(19) United States
(12) Patent Application Publication
(10) Pub. No.: US 2016/0139303 A1
(43) Pub. Date: May 19, 2016

(54) CELLULOSE ACYLATE FILM, NOVEL COMPOUND, POLARIZING PLATE, AND LIQUID-CRYSTAL DISPLAY DEVICE

(71) Applicant: FUJIFILM Corporation, Tokyo (JP)

(72) Inventors: Aiko YOSHIDA, Kanagawa (JP); Naozumi SHIRAIWA, Kanagawa (JP); Hiroshi INADA, Kanagawa (JP); Yasukazu KUWAYAMA, Kanagawa (JP); Nobutaka FUKAGAWA, Kanagawa (JP); Yingjie XU, Kanagawa (JP); Masaki NORO, Kanagawa (JP)

(73) Assignee: FUJIFILM Corporation, Tokyo (JP)

(21) Appl. No.: 15/003,481

(22) Filed: Jan. 21, 2016

Related U.S. Application Data
(63) Continuation of application No. PCT/JP2014/069823, filed on Jul. 28, 2014.

(30) Foreign Application Priority Data
Jul. 26, 2013 (JP) 2013-156150

(51) Int. Cl. G02B 1/14; C08J 5/18; G02B 5/30; G02F 1/1335; G02B 1/04

(52) U.S. Cl. CPC G02B 1/14; G02F 1/133528; G02B 1/04; G02B 5/3033; C08J 5/18; C08J 2301/10

(57) ABSTRACT

Disclosed is a cellulose acylate film containing a compound having at least one connecting group selected from a group consisting of a bivalent connecting group denoted by —NH—(C═O)—O— and a bivalent connecting group denoted by —NH—(C═O)—NR— in which R represents a hydrogen atom or a substituent group, and at least one polar group which is a residue of a compound having a C log P value of less than or equal to 0.85 (however, an aromatic hetero ring-containing group which is a residue of a compound having a C log P value of less than or equal to 0.85 is excluded from the polar group), in which an equivalent weight U obtained as a value which is obtained by dividing a molecular weight by the number of connecting groups included in one molecule is less than or equal to 515.

### CROSS-REFERENCE TO RELATED APPLICATIONS

This application is a Continuation of PCT International Application No. PCT/JP2014/069823 filed on Jul. 28, 2014, which claims priority under 35 U.S.C §119(a) to Japanese Patent Application No. 2013-156150 filed on Jul. 26, 2013. Each of the above applications is hereby expressly incorporated by reference, in its entirety.

### BACKGROUND OF THE INVENTION

1. Field of the Invention

The present invention relates to a cellulose acylate film, and a polarizing plate and a liquid-crystal display device. In particular, the present invention relates to a cellulose acylate film which is useful as a polarizing plate protective film, and a polarizing plate including the cellulose acylate film and a liquid-crystal display device including the polarizing plate.

Further, the present invention relates to a novel compound which is useful as an additive for a cellulose acylate film.

2. Description of the Related Art

A cellulose acylate film has been widely used as an optical compensation film, a protective film, a substrate film, and the like of a display device such as a liquid-crystal display device. In order to improve performance of such a cellulose acylate film, adding an additive, for example, is proposed in JP2004-175971A and JP2005-272566A.

### SUMMARY OF THE INVENTION

Recently, a display device has been enlarged and thinned, focusing on the application to a television, and according to this, a cellulose acylate film configuring the display device has been increasingly required to be thinned. In this regard, according to the studies of the present inventors, it has been found that, in a thinned liquid-crystal display device, surface hardness of the film particularly affects performance of the liquid-crystal display device performance. In particular, it has been found that surface hardness of a protective film used in a surface of a polarizing plate on a viewer side greatly affects the performance of the liquid-crystal display device.

However, in JP2004-175971A, it is disclosed that strength of the entire cellulose acylate film is able to be improved by adding additives disclosed in JP2004-175971A, but improvement in the surface hardness is not disclosed. In addition, in JP2005-272566A, dynamic properties of the film are not disclosed at all.

An object of the present invention is to solve such problems of the related art and to provide a cellulose acylate film having excellent surface hardness.

As a result of intensive studies of the present inventors on the basis of the object described above, it has been newly found that a compound having a specific structure is blended with a cellulose acylate film, and thus it is possible to improve surface hardness of the cellulose acylate film, and it is possible to provide a thinned cellulose acylate film having high surface hardness. The present inventors have assumed that this is because the compound which contains a connecting group described below at a predetermined ratio and has a polar group has a mutual interaction with respect to a local portion such as an ester bond or a hydroxyl group of cellulose acylate or a molecular chain, and decreases free volume, and thus contributes to improvement in the surface hardness of the cellulose acylate film.

The present invention has been accomplished on the basis of the knowledge described above.

According to one aspect of the present invention, there is provided a cellulose acylate film containing a compound having at least one connecting group selected from a group consisting of a bivalent connecting group denoted by —NH—(C═O)—O— and a bivalent connecting group denoted by —NH—(C═O)—NR— in which R represents a hydrogen atom or a substituent group, and at least one polar group which is a residue of a compound having a C log P value of less than or equal to 0.85, in which an aromatic hetero ring-containing group which is a residue of a compound having a C log P value of less than or equal to 0.85 is excluded from the polar group, and an equivalent weight U obtained as a value which is obtained by dividing a molecular weight by the number of connecting groups included in one molecule, that is, U=[(Molecular Weight)/(Number of Connecting Groups Included in One Molecule)] is less than or equal to 515.

Furthermore, the aromatic hetero ring-containing group excluded from the polar group is a group which is the residue of the compound having a C log P value of less than or equal to 0.85 and has an aromatic hetero ring. The aromatic hetero ring indicates a ring structure having a hetero atom in an aromatic ring. Examples of the aromatic hetero ring include a triazine ring.

In addition, in one aspect, the bivalent connecting group denoted by —NH—(C═O)—O— or —NH—(C═O)—NR— may be included in the polar group.

In one aspect, the compound has at least one of the polar groups as a terminal substituent group.

In one aspect, the polar group is selected from a group consisting of a cyano group, a cyclic imide group, an alkoxy carbonyl group, a hydroxyl group, an alkyl aminocarbonyl oxy group, an alkoxy carbonyl amino group, and an alkyl aminocarbonyl amino group.

In one aspect, the compound is a compound denoted by Formula A described below.

Q^{A}-L¹-X—C(═O)—NH-L²-Q^{B} Formula A

[In Formula A, X represents —O— or —NR—, and R represents a hydrogen atom or a substituent group; L¹ and L² each independently represent a single bond, or any one of an alkylene group, an arylene group, —O—, —NR¹—, —S—, and —C(═O)— or a group formed of a combination of two or more types thereof; R¹ represents a hydrogen atom or a substituent group; Q^{A} and Q^{B} each independently represent a substituent group, and at least one of Q^{A} and Q^{B} represents the polar group or the terminal group included in the polar group; and X represents —NR—, L¹ represents a single bond, and when Q^{A} has a ring structure, the ring structure included in Q^{A} may be a ring structure formed along with R of —NR—.]

In one aspect, the compound denoted by Formula A is a compound denoted by Formula A-1 described below.

(Q¹-L¹¹-A-L²¹)ₘ-Z¹ Formula A-1

[In Formula A-1, L¹¹ and L²¹ each independently represent a single bond, or any one of an alkylene group, an arylene group, —O—, —NR¹—, —S—, and —C(═O)— or a group formed of a combination of two or more types thereof; R¹ represents a hydrogen atom or a substituent group; Q¹ represents a substituent group, Z¹ represents a m-valent connecting group, A represents a single bond, *—X—C(═O)—NH—, or *—NH—C(═O)—X—, * represents a bonding position with respect to L²¹, X represents —O— or —NR—, and R represents a hydrogen atom or a substituent group; m represents an integer in a range of 2 to 6, and a plurality of Q¹s, As, L¹¹ and L²¹s may be identical to each other or different from each other, respectively; and at least one A represents *—X—C(═O)—NH— or *—NH—C(═O)—X—, and at least one Q¹ represents the polar group or the terminal group included in the polar group.]

In one aspect, in Formula A-1, the connecting group represented by Z¹ is a chain aliphatic group or a cyclic aliphatic group, or an aromatic group.

In one aspect, in Formula A-1, at least one of L¹¹, L²¹, Q¹, and Z¹ has a ring structure.

In one aspect, in Formula A-1, the polar group represented by at least one of the plurality of Q¹s has a ring structure.

In one aspect, in Formula A-1, at least one of the plurality of Q's is the terminal group included in the polar group, and the terminal group is an alkyl group.

In one aspect, in Formula A-1, at least one of the plurality of Q's is the terminal group included in the polar group, L¹¹ adjacent to Q¹ which is the terminal group is a single bond, and the polar group is configured of Q¹ and A represented by *—X—C(═O)—NH— or *—NH—C(═O)—X—.

In one aspect, in Formula A-1, m is 2 or 3.

In one aspect, in Formula A-1, L²¹ of at least one constituent unit of a plurality of constituent units denoted by (Q¹-L¹¹-A-L²¹) is a single bond, and in the constituent unit, A represents *—NH—C(═O)—X— and is bonded to Z¹ in a bonding position *.

In one aspect, the compound is selected from a group consisting of a compound denoted by Formula A-4 described below and a compound denoted by Formula A-5 described below.

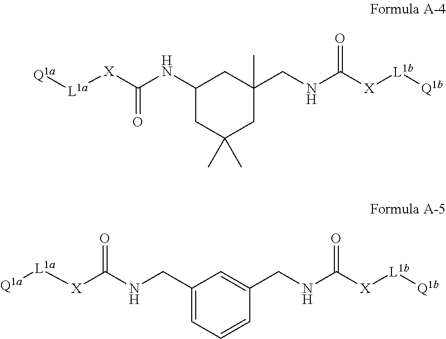

[In Formulas A-4 and A-5, L^{1a} and L^{1b} each independently represent a single bond, or any one of an alkylene group, an arylene group, —O—, and —C(═O)— or a group formed of a combination of two or more thereof; X represents —O— or —NR—, and R represents a hydrogen atom or a substituent group. A plurality of Xs may be identical to each other or different from each other; Q^{1a} and Q^{1b} each independently represent a cyano group, a hydroxyl group, a succinimide group, a hexahydrophthalimide group, a methoxy carbonyl group, an alkoxy carbonyl amino group, an alkyl aminocarbonyl oxy group, an alkyl aminocarbonyl amino group, an alkyl group, a phenyl group, or a benzyl group, or when adjacent L^{1a} or L^{1b} represents a single bond, and X represents —NR—, Q^{1a} and Q^{1b} each independently represent a morpholino group formed along with R of —NR—; and at least one of Q^{1a} and Q^{1b} represents the polar group or the terminal group included in the polar group.]

In one aspect, a content of the compound in the cellulose acylate film is in a range of 1 part by mass to 50 parts by mass with respect to 100 parts by mass of cellulose acylate.

According to another aspect of the present invention, there is provided a polarizing plate including the cellulose acylate film; and a polarizer.

According to still another aspect of the present invention, there is provided a liquid-crystal display device including the polarizing plate.

In one aspect, the liquid-crystal display device includes the polarizing plate at least on a visible side.

According to still another aspect of the present invention, there is provided a compound denoted by Formula A-6 described below and having an equivalent weight U of less than or equal to 515 obtained as a value which is obtained by dividing a molecular weight by the number of connecting groups included in one molecule.

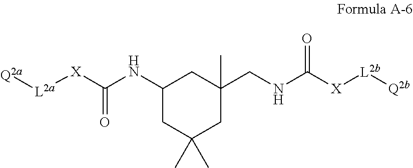

[In Formula A-6, Q^{2a} and Q^{2b} each independently represent a cyano group, a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, a 2-propyl aminocarbonyl oxy group, an alkyl group, a phenyl group, or a benzyl group, and at least one of Q^{2a} and Q^{2b} represents a cyano group, a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, or a 2-propyl aminocarbonyl oxy group; L^{2a} and L^{2b} each independently represent a single bond, or any one of an alkylene group, an arylene group, —O—, and —C(═O)— or a group formed of a combination of two or more thereof; X represents —O— or —NR¹—, and R¹ represents a hydrogen atom or a substituent group; and a plurality of Xs may be identical to each other or different from each other.]

According to still another aspect of the present invention, there is provided a compound denoted by Formula A-7 described below and having an equivalent weight U of less than or equal to 515 obtained as a value which is obtained by dividing a molecular weight by the number of bivalent connecting groups denoted by —X—(C═O)—NH— and included in one molecule.

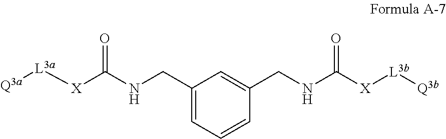

[In Formula A-7, one of Q^{3a} and Q^{3b} represents a cyano group, a succinimide group, or a hexahydrophthalimide group, and the other of Q^{3a} and Q^{3b} represents an alkyl group, a phenyl group, or a benzyl group; L^{3a} and L^{3b} each independently represent a single bond, or any one of an alkylene group, an arylene group, —O—, and —C(═O)— or a group formed of a combination of two or more thereof; X represents —O— or —NR—, and R represents a hydrogen atom or a substituent group; and a plurality of Xs may be identical to each other or different from each other.]

According to still another aspect of the present invention, there is provided a compound denoted by Formula A-8 described below and having an equivalent weight U of less than or equal to 515 obtained as a value which is obtained by dividing a molecular weight by the number of bivalent connecting groups denoted by —X—(C═O)—NH— and included in one molecule.

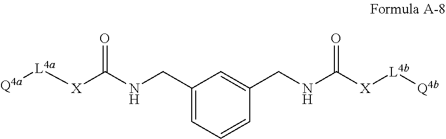

[In Formula A-8, Q^{4a} and Q^{4b} each independently represent a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, a 2-propyl aminocarbonyl oxy group, an alkyl group, a phenyl group, or a benzyl group, and at least one of Q^{4a} and Q^{4b} represents a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, or a 2-propyl aminocarbonyl oxy group; L^{4a} and L^{4b} each independently represent a single bond, or any one of an alkylene group, an arylene group, —O—, and —C(═O)— or a group formed of a combination of two or more thereof; X represents —O— or —NR—, and R represents a hydrogen atom or a substituent group; and a plurality of Xs may be identical to each other or different from each other.]

According to still another aspect of the present invention, there is provided a compound denoted by Formula A-9 described below and having an equivalent weight U of less than or equal to 515 obtained as a value which is obtained by dividing a molecular weight by the number of bivalent connecting groups denoted by —X—(C═O)—NH— and included in one molecule.

Q¹⁰⁰-(L¹⁰⁰-A¹⁰⁰)m1-Q¹⁰¹ Formula A-9:

[In Formula A-9, L¹⁰⁰ represents any one of a single bond, an alkylene group, and

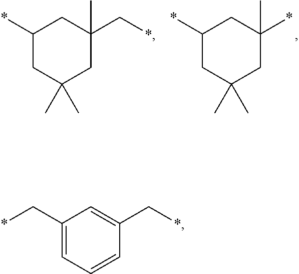

represents a bonding position with respect to the other structure configuring the compound denoted by Formula A-9, and one or more of a plurality of L¹⁰⁰s represent a group other than the single bond; Q¹⁰⁰ and Q¹⁰¹ each independently represent an alkyl group, a hydroxyl group, or a cyano group; A¹⁰⁰ represents *—X—C(═O)—NH— or *—NH—C(—O)—X—, * represents a bonding position with respect to L¹⁰⁰, X represents —O— or —NR—, and R represents a hydrogen atom or a substituent group; and m1 represents an integer in a range of 2 to 6.]

According to the present invention, it is possible to provide a cellulose acylate film having high surface hardness. Further, according to the present invention, it is possible to provide a cellulose acylate film in which the yellowish film due to light irradiation (photo-coloration properties) is suppressed, and volatilization of the added compound decreases. By using such a cellulose acylate film, it is possible to provide a high-quality polarizing plate having high durability and a liquid-crystal display device including the polarizing plate.

### BRIEF DESCRIPTION OF THE DRAWINGS

FIG. 1 illustrates an example of a positional relationship between a polarizing plate and a liquid-crystal display device according to one aspect of the present invention.

### DESCRIPTION OF THE PREFERRED EMBODIMENTS

Hereinafter, the present invention will be described in more detail. Furthermore, in the present invention and in the present specification, “to” is used as the meaning which includes the numerical values before and after “to” as the lower limit value and the upper limit value. In the present invention and in the present specification, a “group” such as an alkyl group, unless otherwise particularly stated, may have a substituent group, or may not have a substituent group. Further, when the number of carbon atoms is limited in a group, the number of carbon atoms indicates the number of carbon atoms included in a substituent group.

In the present invention, a cellulose acylate film is a film in which a content ratio of cellulose acylate is greater than or equal to 50 mass % with respect to 100 mass % of the total amount of film solid contents. The content ratio of the cellulose acylate is preferably greater than or equal to 60 mass %, is more preferably greater than or equal to 70 mass %, is even more preferably greater than or equal to 80 mass %, and is still more preferably greater than or equal to 85 mass %. The upper limit value of the content ratio of the cellulose acylate, for example, is less than or equal to 99 mass %, but is not particularly limited. The cellulose acylate film of the present invention may be in the shape of a laminated film of two or more cellulose acylate films having different compounds, or may be in the shape of a laminated film of the cellulose acylate film and a film or a layer other than the cellulose acylate film. Examples of the film or the layer other than the cellulose acylate film, which configures the laminated film, are able to include various functional layers specialized for a specific function. Examples of such a functional layer include a hard coat layer described below, but are not limited thereto.

The cellulose acylate film of the present invention contains a compound having at least one connecting group selected from a group consisting of a bivalent connecting group denoted by —NH—(C═O)—O— and a bivalent connecting group denoted by —NH—(C═O)—NR— in which R represents a hydrogen atom or a substituent group, and at least one polar group which is a residue of a compound having a C log P value of less than or equal to 0.85, and in the compound, an equivalent weight U obtained as U=[(Molecular Weight)/(Number of Connecting Groups Included in One Molecule)] is less than or equal to 515.

The present inventors have considered that a decrease in the free volume of the compound by a mutual interaction between the connecting group included in the compound in a predetermined amount and a local portion such as an ester bond or a hydroxyl group of cellulose acylate or a molecular chain contributes to improvement in the surface hardness of the cellulose acylate film. Further, the present inventors have assumed that improvement in compatibility between the cellulose acylate and the compound by the polar group included in the compound along with the connecting group contributes to strengthening a mutual interaction. By adding such a compound, as described in the following examples, it is possible to provide a cellulose acylate film having high surface hardness. Therefore, the compound is useful as an additive for a cellulose acylate film. Furthermore, as described above, an aromatic hetero ring-containing group which is the residue of the compound having a C log P value of less than or equal to 0.85 is excluded from the polar group.

Hereinafter, the compound will be described in more detail.

The compound includes at least one connecting group selected from a group consisting of a bivalent connecting group denoted by —NH—(C═O)—O— and a bivalent connecting group denoted by —NH—(C═O)—NR— in which R represents a hydrogen atom or a substituent group in one molecule. Examples of the substituent group represented by R are able to include substituent groups described below as a group of substituent groups T. The connecting group is a group which is able to be obtained by the mutual interaction with respect to the cellulose acylate. Then, the compound includes the connecting group at a ratio where the equivalent weight U obtained as U=[(Molecular Weight)/(Number of Connecting Groups Included in One Molecule)] is less than or equal to 515. A content ratio of the connecting group per one molecule increases as the value of the equivalent weight U decreases. According to the compound having the value of the equivalent weight U of less than or equal to 515 and the polar group, it is possible to obtain a cellulose acylate film having high surface hardness. The value of the equivalent weight U is preferably less than or equal to 450, is more preferably less than or equal to 420, and is even more preferably less than or equal to 300. The lower limit value is not particularly limited, but for example, is greater than or equal to 100.

The compound includes at least one connecting group selected from the group described above, preferably includes one or more connecting groups, more preferably includes 1 to 15 connecting groups, even more preferably includes 1 to 10 connecting groups, and still more preferably includes 2 to 8 connecting groups, in one molecule. When a plurality of connecting groups selected from the group described above are included in one molecule of the compound, all of the plurality of connecting groups may be identical to each other or different from each other. It is more preferable that 2 to 6 connecting groups selected from the group described above are included in one molecule. In this case, in one preferred aspect, the compound includes two bivalent connecting group denoted by —NH—(C═O)—O— in one molecule. In another preferred aspect, the compound includes one bivalent connecting group denoted by —NH—(C═O)—O— and one bivalent connecting group denoted by —NH—(C═O)—NR— in one molecule.

When a plurality of connecting groups selected from the group described above are included in the compound, the connecting groups may be connected through the other connecting group. Preferably, the other connecting group exists between the connecting groups selected from the group described above. Examples of such a connecting group include the connecting group represented by Z¹ of Formula A-1 described below or the connecting group represented by Z¹. It is preferable that the connecting group existing between the connecting groups selected from the group described above has a chain structure, a branch structure, or a ring structure from a viewpoint of improving the surface hardness of the cellulose acylate film. It is more preferable that the connecting group existing between the connecting groups selected from the group described above is a connecting group having a chain aliphatic group or a cyclic aliphatic group, or an aromatic group. The ring structure may be a carbon ring or a hetero ring, and it is preferable that the ring structure is a carbon ring. It is more preferable that the ring structure is a cyclohexane ring which may have a substituent group or a benzene ring which may have a substituent group, and it is even more preferable that the ring structure is a cyclohexane ring which may have a substituent group or a non-substitutional benzene ring.

Examples of the substituent group include the group of substituent groups T described below. In addition, unless otherwise particularly stated, the substituent group in the present invention is a substituent group selected from the group of substituent groups T described below. Examples of the substituent group which is substituted for the ring structure include an alkyl group having 1 to 3 carbon atoms (for example, a methyl group, an ethyl group, a 1-propyl group, a 2-propyl group (an isopropyl group), and the like, and preferably a methyl group), and an alkoxy group having 1 to 3 carbon atoms (for example, a methoxy group, an ethoxy group, and the like).

Group of Substituent Groups T:

An alkyl group (preferably an alkyl group having 1 to 20 carbon atoms, more preferably an alkyl group having 1 to 12 carbon atoms, particularly preferably an alkyl group having 1 to 8 carbon atoms, and for example, a methyl group, an ethyl group, a 1-propyl group, a 2-propyl group, a tert-butyl group, an n-octyl group, an n-decyl group, an n-hexadecyl group, a cyclopropyl group, a cyclopentyl group, a cyclohexyl group, and the like), an alkenyl group (preferably an alkenyl group having 2 to 20 carbon atoms, more preferably an alkenyl group having 2 to 12 carbon atoms, particularly preferably an alkenyl group having 2 to 8 carbon atoms, and for example, a vinyl group, an allyl group, a 2-butenyl group, a 3-pentenyl group, and the like), an alkynyl group (preferably an alkynyl group having 2 to 20 carbon atoms, more preferably an alkynyl group having 2 to 12 carbon atoms, particularly preferably an alkynyl group having 2 to 8 carbon atoms, and for example, a propargyl group, a 3-pentynyl group, and the like), an aryl group (preferably an aryl group having 6 to 30 carbon atoms, more preferably an aryl group having 6 to 20 carbon atoms, particularly preferably an aryl group having 6 to 12 carbon atoms, and for example, a phenyl group, a biphenyl group, a naphthyl group, and the like), an amino group (preferably an amino group having 0 to 20 carbon atoms, more preferably an amino group having 0 to 10 carbon atoms, particularly preferably an amino group having 0 to 6 carbon atoms, and for example, an amino group, a methyl amino group, a dimethyl amino group, a diethyl amino group, a dibenzyl amino group, and the like), an alkoxy group (preferably an alkoxy group having 1 to 20 carbon atoms, more preferably an alkoxy group having 1 to 12 carbon atoms, particularly preferably an alkoxy group having 1 to 8 carbon atoms, and for example, a methoxy group, an ethoxy group, a butoxy group, and the like), an aryl oxy group (preferably an aryl oxy group having 6 to 20 carbon atoms, more preferably an aryl oxy group having 6 to 16 carbon atoms, particularly preferably an aryl oxy group having 6 to 12 carbon atoms, and for example, a phenyl oxy group, a 2-naphthyl oxy group, and the like), an acyl group (preferably an acyl group having 1 to 20 carbon atoms, more preferably an acyl group having 1 to 16 carbon atoms, particularly preferably an acyl group having 1 to 12 carbon atoms, and for example, an acetyl group, a benzoyl group, a formyl group, a pivaloyl group, and the like), an alkoxy carbonyl group (preferably an alkoxy carbonyl group having 2 to 20 carbon atoms, more preferably an alkoxy carbonyl group having 2 to 16 carbon atoms, particularly preferably an alkoxy carbonyl group having 2 to 12 carbon atoms, and for example, a methoxy carbonyl group, an ethoxy carbonyl group, and the like), an aryl oxy carbonyl group (preferably an aryl oxy carbonyl group having 7 to 20 carbon atoms, more preferably an aryl oxy carbonyl group having 7 to 16 carbon atoms, particularly preferably an aryl oxy carbonyl group having 7 to 10 carbon atoms, and for example, a phenyl oxy carbonyl group, and the like), an acyl oxy group (preferably an acyl oxy group having 2 to 20 carbon atoms, more preferably an acyl oxy group having 2 to 16 carbon atoms, particularly preferably an acyl oxy group having 2 to 10 carbon atoms, and for example, an acetoxy group, a benzoyl oxy group, and the like), an acyl amino group (preferably an acyl amino group having 2 to 20 carbon atoms, more preferably an acyl amino group having 2 to 16 carbon atoms, particularly preferably an acyl amino group having 2 to 10 carbon atoms, and for example, an acetyl amino group, a benzoyl amino group, and the like), an alkoxy carbonyl amino group (preferably an alkoxy carbonyl amino group having 2 to 20 carbon atoms, more preferably an alkoxy carbonyl amino group having 2 to 16 carbon atoms, particularly preferably an alkoxy carbonyl amino group having 2 to 12 carbon atoms, and for example, a methoxy carbonyl amino group, and the like), an aryl oxy carbonyl amino group (preferably an aryl oxy carbonyl amino group having 7 to 20 carbon atoms, more preferably an aryl oxy carbonyl amino group having 7 to 16 carbon atoms, particularly preferably an aryl oxy carbonyl amino group having 7 to 12 carbon atoms, and for example, a phenyl oxy carbonyl amino group, and the like), a sulfonyl amino group (preferably a sulfonyl amino group having 1 to 20 carbon atoms, more preferably a sulfonyl amino group having 1 to 16 carbon atoms, particularly preferably a sulfonyl amino group having 1 to 12 carbon atoms, and for example, a methane sulfonyl amino group, a benzene sulfonyl amino group, and the like), a sulfamoyl group (preferably a sulfamoyl group having 0 to 20 carbon atoms, more preferably a sulfamoyl group having 0 to 16 carbon atoms, particularly preferably a sulfamoyl group having 0 to 12 carbon atoms, and for example, a sulfamoyl group, a methyl sulfamoyl group, a dimethyl sulfamoyl group, a phenyl sulfamoyl group, and the like), a carbamoyl group (preferably a carbamoyl group having 1 to 20 carbon atoms, more preferably a carbamoyl group having 1 to 16 carbon atoms, particularly preferably a carbamoyl group having 1 to 12 carbon atoms, and for example, a carbamoyl group, a methyl carbamoyl group, a diethyl carbamoyl group, a phenyl carbamoyl group, and the like), an alkyl thio group (preferably an alkyl thio group having 1 to 20 carbon atoms, more preferably an alkyl thio group having 1 to 16 carbon atoms, particularly preferably an alkyl thio group having 1 to 12 carbon atoms, and for example, a methyl thio group, an ethyl thio group, and the like), an aryl thio group (preferably an aryl thio group having 6 to 20 carbon atoms, more preferably an aryl thio group having 6 to 16 carbon atoms, particularly preferably an aryl thio group having 6 to 12 carbon atoms, an for example, a phenyl thio group, and the like), a sulfonyl group (preferably a sulfonyl group having 1 to 20 carbon atoms, more preferably a sulfonyl group having 1 to 16 carbon atoms, particularly preferably a sulfonyl group having 1 to 12 carbon atoms, and for example, a mesyl group, a tosyl group, and the like), a sulfinyl group (preferably a sulfinyl group having 1 to 20 carbon atoms, more preferably a sulfinyl group having 1 to 16 carbon atoms, particularly preferably a sulfinyl group having 1 to 12 carbon atoms, and for example, a methane sulfinyl group, a benzene sulfinyl group, and the like), a urethane group, a ureido group (preferably a ureido group having 1 to 20 carbon atoms, more preferably a ureido group having 1 to 16 carbon atoms, particularly preferably a ureido group having 1 to 12 carbon atoms, and for example, a ureido group, a methyl ureido group, a phenyl ureido group, and the like), a phosphoric amide group (preferably a phosphoric amide group having 1 to 20 carbon atoms, more preferably a phosphoric amide group having 1 to 16 carbon atoms, particularly preferably a phosphoric amide group having 1 to 12 carbon atoms, and for example, diethyl phosphoric amide, phenyl phosphoric amide, and the like), a hydroxyl group, a mercapto group, a halogen atom (for example, a fluorine atom, a chlorine atom, a bromine atom, and an iodine atom), a cyano group, a sulfo group, a carboxyl group, a nitro group, a hydroxamic acid group, a sulfino group, a hydrazino group, an imino group, a heterocyclic group (preferably a heterocyclic group having 1 to 30 carbon atoms, more preferably a heterocyclic group having 1 to 12 carbon atoms in which examples of a hetero atom includes a nitrogen atom, an oxygen atom, and a sulfur atom, and specifically, for example, an imidazolyl group, a pyridyl group, a quinolyl group, a furyl group, a piperidyl group, a morpholino group, a benzooxazolyl group, a benzimidazolyl group, a benzthiazolyl group, and the like), and a silyl group (preferably a silyl group having 3 to 40 carbon atoms, more preferably a silyl group having 3 to 30 carbon atoms, particularly preferably a silyl group having 3 to 24 carbon atoms, and for example, a trimethyl silyl group, a triphenyl silyl group, and the like).

The substituent groups may be further substituted. In addition, when two or more substituent groups are used, the substituent groups may be identical to each other or different from each other. In addition, when it is possible, the substituent groups may be connected to each other and may form a ring.

In JP2004-175971A described above, an additive for improving toughness of the film is disclosed, but the present inventors have examined the additive disclosed in JP2004-175971A, and have found that the yellowish film occurs according to continuous light irradiation (hereinafter, referred to as photo-coloration properties) due to absorption at 275 nm or higher. In consideration of this point, it is preferable that a compound used as an additive for a cellulose acylate film does not cause the photo-coloration properties of the film. From this viewpoint, in one aspect, it is preferable that the compound is a compound allowing the cellulose acylate film to which the compound is added to have low photo-coloration properties. The present inventors have considered that the structure of the connecting group, with which the connecting group selected from the group described above is connected to the other structure included in the compound, affects the photo-coloration properties. The connecting group selected from the group described above is connected to the other structure configuring the compound by a nitrogen atom or an oxygen atom. It is preferable that the connecting group is an alkylene group from a viewpoint of suppressing the photo-coloration properties. The details of the alkylene group are identical to those of the alkylene group represented by L¹ and L² of Formula A described below. In addition, it is preferable that in the connecting group selected from the group described above, a nitrogen atom or an oxygen atom is not directly bonded to an aromatic ring from a viewpoint of suppressing the photo-coloration properties. In addition, it is more preferable that two or more connecting groups selected from the group described above are not directly bonded to the same aromatic ring. According to such a structure, it is possible to suppress expansion of a conjugate structure in the molecules, and thus it is possible to obtain a more excellent photo-coloration property suppression effect.

The compound includes a polar group along with the connecting group selected from the group described above. Here, the polar group is a residue of a compound having a C log P value of less than or equal to 0.85. Here, P of C log P represents a distribution coefficient in an n-octanol-water system, and is able to be measured by using n-octanol and water, and an estimated value is able to be obtained from the distribution coefficient by using a C log P value estimation program (a C LOG P program incorporated in PC Models manufactured by Daylight Chemical Information Systems Inc.). The C log P value is calculated as the compound. In order to calculate the C log P value, a target residue from which C log P is obtained is input as complete molecules not as radicals or ions. For example, residues B¹ and B² are determined as a B¹—H portion and a B²—H portion along with a hydrogen atom. Practically, even when the compound has a structure which does not exist, the C log P value is able to be obtained as a value estimated by a calculating chemical method or an empirical method.

The compound includes at least one polar group which is the residue of the compound having a C log P value of less than or equal to 0.85 in one molecule. It is considered that strengthening a mutual interaction between the compound and the cellulose acetate by including such a polar group contributes to improvement in the surface hardness of the cellulose acylate film to be obtained. In consideration of compatibility with respect to the cellulose acylate, the number of polar groups included in one molecule is preferably 1 to 3, and is more preferably 2 or 3. When a plurality of polar groups are included in the compound, it is preferable that at least one polar group exists as a terminal substituent group. Alternatively, the polar group may be included in a substituent group of the group represented by R of —NR—C(═O)—NH—. When a cyano group is included in R, it is preferable that the cyano group is bonded to a nitrogen atom configuring —NR— through an alkylene group (for example, an alkylene group having 1 to 3 carbon atoms).

The C log P value described above is preferably less than or equal to 0.50, is more preferably less than or equal to 0.30, and is even more preferably less than or equal to 0. In addition, it is more preferable that the C log P value of the polar group is greater than or equal to −5.0 from a viewpoint of compatibility with respect to the cellulose acylate. Specifically, examples of the polar group include a cyano group, a cyclic imide group or a chain imide group (for example, a phthalimide group, a succinimide group, a hexahydrophthalimide group, and the like), a nitro group, a hydroxyl group, a sulfone amide group, a carbon amide group, a carboxyl group, an amino group, a monovalent substituent group denoted by —(NR)n1-(C═O)—OR (here, R represents a hydrogen atom or a substituent group, two Rs may be identical to each other or different from each other, respectively, and n1 represents 0 or 1), an aminocarbonyl oxy group (—O—(C—O)—NRR, here, R represents a hydrogen atom or a substituent group, and two Rs may be identical to each other or different from each other, respectively), and an aminocarbonyl amino group (—NR—(C═O)—NRR, here, R represents a hydrogen atom or a substituent group, and a plurality of Rs may be identical to each other or different from each other, respectively). Preferably, examples of the polar group include a cyano group, an imide group, an alkoxy carbonyl group (—(C═O)—OR¹⁰⁰, here, R¹⁰⁰ represents an alkyl group), a hydroxyl group, an alkyl aminocarbonyl oxy group (—O—(C═O)—NR—R¹⁰⁰, here, R represents a hydrogen atom or a substituent group, and R¹⁰⁰ represents an alkyl group), an alkoxy carbonyl amino group (—NR—(C═O)—OR¹⁰⁰ (here, R represents a hydrogen atom or a substituent group, and R¹⁰⁰ represents an alkyl group), and an alkyl aminocarbonyl amino group (—NR—(C—O)—NR—R¹⁰⁰, here, R represents a hydrogen atom or a substituent group, two Rs may be identical to each other or different from each other, respectively, and R¹⁰⁰ represents an alkyl group).

A cyclic imide group is preferable as the imide group described above. A succinimide group, a phthalimide group, and a hexahydrophthalimide group are preferable as the cyclic imide group.

In addition, it is preferable that the alkyl group represented by R¹⁰⁰ is an alkyl group having 1 to 3 carbon atoms. It is more preferable that the alkyl aminocarbonyl oxy group is a methyl aminocarbonyl oxy group in which R¹⁰⁰ is a methyl group, and R is a hydrogen atom. It is preferable that the alkoxy carbonyl group is an alkoxy carbonyl group in which R¹⁰⁰ is an alkyl group having 1 to 3 carbon atoms, and it is more preferable that the alkoxy carbonyl group is a methoxy carbonyl group in which R¹⁰⁰ is a methyl group. It is preferable that the alkoxy carbonyl amino group is an alkoxy carbonyl amino group in which R¹⁰⁰ is an alkyl group having 1 to 3 carbon atoms, and it is more preferable that the alkoxy carbonyl amino group is a methoxy carbonyl amino group in which R¹⁰⁰ is a methyl group. It is preferable that the alkyl aminocarbonyl amino group is an alkyl aminocarbonyl amino group in which R¹⁰⁰ is an alkyl group having 1 to 3 carbon atoms, and it is more preferable that the alkyl aminocarbonyl amino group is a methyl aminocarbonyl amino group in which R¹⁰⁰ is a methyl group.

In one aspect, when the compound includes a polar group selected from a group consisting of an alkyl aminocarbonyl oxy group and an alkyl aminocarbonyl amino group as one terminal substituent group, it is preferable that the other terminal substituent group does not include a ring structure other than a ring structure included in a cyclic imide group.

In addition, including at least one ring structure in the compound is preferable from a viewpoint of improving the surface hardness of the cellulose acylate film to be obtained. From a viewpoint of improving hardness, an aspect in which the ring structure is included in a connecting group existing between the connecting groups selected from the group described above and an aspect in which the ring structure exists as a terminal substituent group are preferable. Furthermore, when the polar group is included as one terminal substituent group, it is also preferable that the ring structure is included in the other terminal substituent group.

Examples of another preferred aspect include an aspect in which the connecting group having the ring structure exists between two connecting groups selected from the group consisting of the bivalent connecting group denoted by —NH—(C═O)—O— and the bivalent connecting group denoted by —NH—(C—O)—NR—. In such an aspect, it is preferable that the polar group does not have a ring structure.

Alternatively, it is also preferable that the polar group described above has a ring structure. As described above, a cyclic imide group is preferable as the polar group having a ring structure. It is preferable that the cyclic polar group exists as a terminal substituent group.

On the other hand, examples of a cyclic group which does not correspond to the polar group described above are able to preferably include a cyclic aliphatic group or an aromatic group having 6 to 30 carbon atoms. A terminal cyclic group which does not correspond to the polar group described above may be a fused ring, and is preferably a single ring. Specifically, examples of the terminal cyclic group include an aliphatic ring (a cyclohexane ring, and the like), an aromatic carbon ring (a benzene ring, a naphthalene ring, and the like), a hetero ring (a morpholine ring, a piperidine ring, a piperazine ring, and the like), and the like, and the aromatic carbon ring is preferable as the terminal cyclic group. Specifically, an aryl group having 6 to 30 carbon atoms (more preferably an aryl group having 6 to 20 carbon atoms, and more preferably an aryl group having 6 to 10 carbon atoms) as the terminal cyclic group, and a benzene ring is particularly preferable as the terminal cyclic group. That is, it is preferable that the terminal cyclic group which does not correspond to the polar group described above is a phenyl group. The phenyl group may be substituted or may not be substituted, and a non-substitutional phenyl group is preferable.

Furthermore, examples of a cyclic group which does not correspond to the polar group described above are able to include a cyclic group (a nitrogen-containing heterocyclic group) formed along with the substituent group represented by R of the bivalent connecting group denoted by —NH—(C═O)—NR—. A nitrogen-containing 6-membered heterocyclic group is preferable as the nitrogen-containing heterocyclic group formed as described above, and a morpholino group is more preferable as the nitrogen-containing heterocyclic group formed as described above. The nitrogen-containing heterocyclic group may have a substituent group, or may be a non-substitutional group. It is preferable that the nitrogen-containing heterocyclic group is a non-substitutional nitrogen-containing heterocyclic group. Examples of a substituent group which is substituted for the nitrogen-containing heterocyclic group are able to include the substituent groups exemplified in the group of substituent groups T described above.

On the other hand, the ring structure included in the connecting group is identical to that described in Z¹ of Formula A-1 described below.

In JP2005-272566A described above, an additive for improving retardation (Rth) in a thickness direction of the film is disclosed, but when the film is thinned, whitening of the film due to volatilization is likely to occur. Therefore, it is preferable that the compound used as an additive for a cellulose acylate film has low volatility from a viewpoint of providing a cellulose acylate film having high transparency. In this regard, in one aspect, the compound is able to exhibit low volatility. From a viewpoint of further reducing the volatilization, the molecular weight of the compound is preferably greater than or equal to 230, is more preferably greater than or equal to 250, is even more preferably greater than or equal to 300, and is still more preferably greater than or equal to 350. In addition, it is preferable that two or more types of compounds having different structures are mixed into the cellulose acylate film. In one aspect, mixing two or more types of compounds is preferable from a viewpoint of reducing the volatility. On the other hand, in order to prevent an increase in haze, it is preferable that a compound having excellent compatibility with respect to the cellulose acylate is used as the additive for a cellulose acylate film. From this viewpoint, the molecular weight of the compound is preferably less than or equal to 2000, and is more preferably less than or equal to 1500.

Furthermore, when the compound is a multimer, the molecular weight indicates a weight average molecular weight. In the present invention, the average molecular weight indicates an average molecular weight measured by gel permeation chromatography (GPC) in terms of polystyrene. Examples of specific measurement conditions are able to include the following measurement conditions. An average molecular weight in the following example is a value measured in the following measurement conditions.

GPC Device: HLC-8320 (manufactured by Tosoh Corporation):

Column: Using TSK gel Super HZM-H, TSK gel Super HZ4000, and TSK gel Super HZ2000 together, (manufactured by Tosoh Corporation, 4.6 mmID (an inner diameter)×15.0 cm)

Eluant: Tetrahydrofuran (THF)

A preferred aspect of the compound described above is a compound denoted by Formula A described below.

Q^{A}-L¹-X—C(—O)—NH-L²Q^{B} Formula A

In Formula A, X represents —O— or —NR—, and R represents a hydrogen atom or a substituent group. L¹ and L² each independently represents a single bond, or any one of an alkylene group, an arylene group, —O—, —NR¹—, —S—, and —C(═O)— or a group formed of a combination of two or more types thereof. R¹ represents a hydrogen atom or a substituent group. Q^{A} and Q^{B} each independently represent a substituent group, and at least one of Q^{A} and Q^{B} represents the polar group described above or the terminal group included in the substituent group described above. When X represents —NR—, L¹ represents a single bond, and Q^{A} has a ring structure, the ring structure included in Q^{A} may be a ring structure formed along with R of —NR—.

In Formula A, X represents —O— or —NR—. R represents a hydrogen atom or a substituent group, and examples of the substituent group include the substituent groups selected from the group of substituent groups T described above. Among them, an alkyl group and an aryl group which may be substituted are preferable as the substituent group, and an alkyl group substituted with a cyano group which is a polar group is more preferable as the substituent group. In Formula A, the connecting group selected from the group described above, specifically, may include one or more bivalent connecting groups denoted by —NH—C(═O)—O—, —O—C(O)—NH—, or —NH—C(—O)—NR—, —NR—C(═O)—NH—. The number of connecting groups selected from the group described above is as described above. In addition, all of the connecting groups selected from the group described above which exist in the compound may be identical to each other or different from each other.

Q^{A} and Q^{B} each independently represent a substituent group, and at least one of Q^{A} and Q^{B} represents the polar group described above or the terminal group included in the polar group described above. The details of the polar group are as described above. In one aspect, when one of Q^{A} and Q^{B} represents the polar group described above or has the polar group described above, it is preferable that the other is a substituent group having a ring structure. The details thereof are as described above.

L¹ and L² each independently represent a single bond, or any one of an alkylene group, an arylene group, —O—, —NR¹—, —S—, and —C(═O)—, or a group formed of a combination of two or more types thereof. An alkylene group having 1 to 20 carbon atoms is more preferable as the alkylene group represented by L¹ and L² or included in L¹ and L², and an alkylene group having 1 to 15 carbon atoms is more preferable as the alkylene group represented by L¹ and L² or included in L¹ and L². The alkylene group may be any one of a straight-chain alkylene group, a branched alkylene group, a cyclic alkylene group. Specific examples of the alkylene group include a methylene group, an ethylene group, a propylene group, a butylene group, a pentylene group, a hexylene group, a cyclohexylene group, a 2,2′-methylene bis(cyclohexylene) group, a hexahydroxylylene group, and the like. The alkylene group may have a substituent group. Examples of the substituent group which may be included in the alkylene group include the group of substituent groups T described below. Among them, an alkyl group, an acyl group, an aryl group, an alkoxy group, and a carbonyl group are preferable as the substituent group included in the alkylene group. In addition, an alkylene group having 1 to 8 carbon atoms is more preferable as the straight-chain alkylene group or the branched alkylene group, an alkylene group having 1 to 3 carbon atoms is even more preferable as the straight-chain alkylene group or the branched alkylene group, a methylene group, an ethylene group, a propylene group, and an isopropylene group are still more preferable as the straight-chain alkylene group or the branched alkylene group. An alkylene group having 3 to 15 carbon atoms is more preferable as the cyclic alkylene group, and an alkylene group having 5 to 10 carbon atoms is even more preferable as the cyclic alkylene group. A cyclohexylene group having a substituent group is preferable as the cyclohexylene group, and an alkyl substituted cyclohexylene group is more preferable as the cyclohexylene group. An alkyl substituted cyclohexylene group having the following structure is able to be exemplified as a preferred alkyl substituted cyclohexylene group. In the following description, * represents a bonding position with respect to the other structure configuring the compound denoted by Formula A.

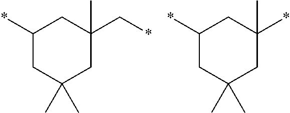

In addition, preferred examples of the alkyl substituted cyclohexylene group are able to include a hexahydroxylylene group described below.

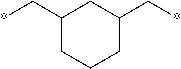 [SMILES: *CC1CCCC(C*)C1]

An arylene group having 5 to 20 carbon atoms is preferable as the arylene group represented by L¹ and L² or included in L¹ and L², an arylene group having 5 to 15 carbon atoms is more preferable as the arylene group represented by L¹ and L² or included in L¹ and L², and an arylene group having 5 to 12 carbon atoms is even more preferable as the arylene group represented by L¹ and L² or included in L¹ and L². Specific examples of the arylene group include a phenylene group, a xylylene group, a biphenylene group, a naphthylene group, a 2,2′-methylene bisphenyl group, and the like. The arylene group may have a substituent group. Examples of the substituent group which may be included in the arylene group include a group of substituent groups T described below. Among them, an alkyl group, an acyl group, an aryl group, an alkoxy group, and a carbonyl group are preferable as the substituent group included in the arylene group. More preferred examples of the arylene group include a xylylene group and a tetramethyl xylylene group.

When L¹ and L² represent any one of an alkylene group, an arylene group, —O—, —NR¹—, —S—, and —C(═O)— or a group formed of a combination of two or more types thereof, it is preferable that L¹ and L² represent any one of an alkylene group, an arylene group, —O—, and —C(═O)— or a group formed of a combination of two or more types thereof. In addition, in the group represented by L¹ and L², the number of carbon atoms in a main chain portion is preferably in a range of 1 to 10, and is more preferably in a range of 1 to 5.

Specific preferred examples of the group represented by L¹ and L² include an alkylene group, and structures denoted by Formulas (2A) to (2E) described below.

-{(CR²¹R²²)ⱼₐ—O—(C═O)}_{jb}-* Formula (2A)

-{(CR²¹R²²)ⱼₐ—O}_{jb}-* Formula (2B)

-{(CR²¹R²²)ⱼₐ—(C═O)—O-}_{jb}-* Formula (2C)

—{(CR²¹R²²)ⱼₐ—NR¹(C═O)—O}_{jb}-* Formula (2D)

-{(CR²¹R²²)ⱼₐ—O—(C═O)—NR¹-}_{jb}-* Formula (2E)

In Formulas (2A) to (2E), * represents a bonding position with respect to the substituent group represented by Q^{A} or Q^{B}, R²¹ and R²² each independently represent a hydrogen atom or an alkyl group having 1 to 3 carbon atoms, ja and jb each independently represent an integer of greater than or equal to 1, and is preferably an integer in a range of 1 to 3, and when a plurality of R²¹s and R²²s exist, the plurality of R²¹s and R²²s may be identical to each other or different from each other, respectively.

In Formulas (2A) to (2E), when two or more structures denoted by —(CR²¹R²²)— are included, it is preferable that all of R²¹ and R²² are hydrogen atoms or at least one of R²¹ and R²² is an alkyl group.

R¹ of —NR¹— represents a hydrogen atom or a substituent group, examples of the substituent group include an alkyl group, an alkenyl group, an aryl group, and an acyl group, and a hydrogen atom or an alkyl group having 1 to 8 carbon atoms, an alkenyl group having 2 to 8 carbon atoms, an alkynyl group having 2 to 8 carbon atoms, and an aryl group having 6 to 18 carbon atoms (for example, a group having a benzene ring and a naphthalene ring) are preferable as the substituent group, and a hydrogen atom or an alkyl group having 1 to 4 carbon atoms is more preferable as the substituent group.

In addition, it is preferable that Q^{A} is a monovalent substituent group denoted by Formula (a) described below or a substituent group in which one or more of this monovalent substituent groups are bonded to L¹ through a connecting group.

*-L¹-X¹—C(═O)—X²-L²-Q^{B} Formula (a)

Alternatively, it is preferable that Q^{B} is a monovalent substituent group denoted by Formula (b) described below or a substituent group in which one or more of this monovalent substituent groups are bonded to L² through a connecting group.

Q^{A}-L¹-X¹—C(═O)—X²-L²-* Formula (b)

In Formulas (a) and (b) described above, * represents a bonding position with respect to the other structure configuring the compound denoted by Formula A, Q^{A}, Q^{B}, L¹, and L² are identical to those of Formula A, respectively, one of X¹ and X² represents —NH—, the other represents —O— or —NR—, and R is identical to that of Formula A. Examples of the connecting group are able to include the connecting groups described in Z¹ of Formula A-1.

That is, it is preferable that the compound denoted by Formula A has two or more structures denoted by *-L¹-X—C(═O)—NH-L²-* in one molecule. In the above description, * represents a bonding position with respect to the other structure configuring the compound denoted by Formula A, and X, L¹, and L² are identical to those of Formula A, respectively.

As described above, in Formula A, when X represents —NR—, L¹ represents a single bond, and Q^{A} has a ring structure, the ring structure included in Q^{A} is able to be a ring structure formed along with R of —NR—. An aspect in which the compound denoted by Formula A has the ring structure described above is denoted by Formula A-a described below.

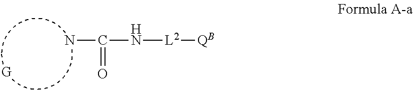

In Formula A-a, G represents an atom group forming a ring structure along with a connecting nitrogen atom, and L² and Q^{B} are identical to those of Formula A, respectively.

The ring structure (a nitrogen-containing hetero ring) formed by G is a substitutional or non-substitutional nitrogen-containing hetero ring, is preferably a substitutional or non-substitutional nitrogen-containing 6-membered hetero ring, and is more preferably a substitutional or non-substitutional morpholino group. As described above, it is preferable the nitrogen-containing hetero ring is a non-substitutional nitrogen-containing hetero ring. An aspect in which the compound denoted by Formula A has a non-substitutional morpholino group is denoted by Formula A-a1 described below.

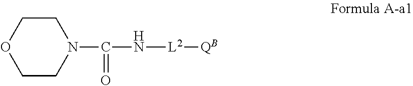

In Formula A-a1, L² and Q^{B} are identical to those of Formula A, respectively.

The preferred aspects of the compound denoted by Formula A are able to include a compound denoted by Formula A-1 described below.

(Q¹-L¹-A-L²¹)ₘ-Z¹ Formula A-1

In Formula A-1, L¹¹ and L²¹ each independently represent a single bond, or any one of an alkylene group, an arylene group, —O—, —NR¹—, —S—, and —C(═O)—, or a group formed of a combination of two or more types thereof. R¹ represents a hydrogen atom or a substituent group. Q¹ represents a substituent group, Z¹ represents an m-valent connecting group, A represents a single bond, *—X—C(═O)—NH—, or *—NH—C(═O)—X—, * represents a bonding position with respect to L²¹, X represents —O— or —NR—, and R represents a hydrogen atom or a substituent group. m represents an integer in a range of 2 to 6, a plurality of Q¹s, As, L¹¹s, and L²¹s may be identical to each other or different from each other, respectively. Here, at least one A represents *—X—C(═O)—NH— or *—NH—C(═O)—X—. In addition, at least one Q¹ represents the polar group described above or the terminal group included in the polar group described above.

Furthermore, as described in Formula A, when A represents *—NH—C(═O)—X—, X represents —NR—, L¹¹ represents a single bond, and Q¹ has a ring structure, the ring structure included in Q¹ may be a ring structure formed along with R of —NR—.

L¹¹ and L²¹ are each independently identical to L¹ and L² of Formula A, and the details of a preferred aspect and the like are identical to those of L¹ and L² of Formula A.

Q¹ represents a substituent group, and preferably, represents the polar group described above or the terminal group included in the polar group described above. Preferred polar groups are as described above.

In addition, it is preferable that any one of m Q¹s represents the polar group described above or the terminal group included in the polar group described above, and in one aspect, it is preferable that all of m Q¹s represent the polar group described above, one of m Q¹s represents the polar group described above and the other represents the terminal group included in the polar group described above, or all of m Q¹s represent the terminal group included in the polar group described above, and it is more preferable that all of the polar groups included in m Q¹s are the polar groups described above as a preferred example. In addition, in another aspect, it is preferable that any one of m Q¹s represents the polar group described above or the terminal group included in the polar group described above, and the other Q¹s represent a substituent group having a ring structure, and it is more preferable that the polar group is the polar group described above as a preferred examples. The details of the substituent group having a ring structure are as described above.

In addition, when Q¹ represents the terminal group included in the polar group described above, in one aspect, the terminal group is preferably an alkyl group.

In addition, when Q¹ represents the terminal group included in the polar group described above, it is preferable that the polar group is configured of the terminal group Q¹ and the connecting group A selected from the group described above. In this case, L¹¹ represents a single bond, and Q¹ and A are directly connected to each other.

It is preferable that the compound denoted by Formula A-1 has a ring structure in the molecules. In one aspect, it is preferable that at least one of Q¹ and Z¹ has a ring structure, and it is more preferable that at least Z¹ has a ring structure. The ring structure which is able to be included in Z¹ will be described below. The ring structure which is able to be included in Q¹ is as described above. Alternatively, in another aspect, it is preferable that Q¹ and Z¹ do not have a ring structure, but any one or both of L¹¹ and L²¹ have a ring structure.

That is, in Formula A-1, it is preferable that at least one of L¹¹, L²¹, Q¹, and Z¹ has a ring structure.

A represents a single bond, *—X—C(═O)—NH—, or *—NH—C(═O)—X—. Here, at least one of a plurality of As represents *—X—C(═O)—NH— or *—NH—C(═O)—X—. X is identical to X of Formula A. That is, at least one of the plurality of As represents the connecting group selected from the group described above. Furthermore, in Formula A-1, m represents an integer in a range of 2 to 6, and thus a plurality of (m) constituent units denoted by (Q¹-L¹¹-A-L²¹) exist in the compound denoted by Formula A-1. In at least one of the plurality of constituent units denoted by (Q¹-L¹¹-A-L²¹), when L²¹ represents a single bond and A represents the connecting group selected from the group described above, the connecting group represented by A is directly bonded to Z¹. In this case, it is preferable that A represents *—NH—C(═O)—X—, and is bonded to Z¹ in a bonding position *. The details of the connecting group selected from the group described above are as described above.

Z¹ represents an m-valent connecting group. m is an integer in a range of 2 to 6, and thus Z¹ is a bivalent to hexavalent connecting group. Z¹ is preferably a bivalent to trivalent connecting group, and is more preferably a bivalent connecting group. Z¹ is preferably a group including at least one of a straight-chain aliphatic group, a branched aliphatic group, or a cyclic aliphatic group and an aromatic group, and is more preferably a group including at least one of a chain aliphatic group or a cyclic aliphatic group and an aromatic group.

Z¹ may be formed of only at least one of the straight-chain aliphatic group, the branched aliphatic group, or the cyclic aliphatic group and the aromatic group, or is preferably a combination of the group and one or more of an oxygen atom and a straight-chain alkylene group or a branched alkylene group. It is preferable that the aliphatic group included as Z¹ is a saturated aliphatic group.

According to the group including at least one of the branched or cyclic aliphatic group and the aromatic group, a rigid structure is obtained, and hardness tends to be improved. The number of carbon atoms configuring Z¹ is preferably 3 to 20, and is more preferably 4 to 15.

Z¹ may have a substituent group, and specific examples of the substituent group include the group of substituent groups T described above. When Z¹ includes the cyclic aliphatic group, it is preferable that the cyclic aliphatic group has a substituent group. On the other hand, when Z¹ includes the aromatic group, it is preferable that the aromatic group does not have a substituent group.

Specifically, it is preferable that Z¹ is a connecting group exemplified as follows. Furthermore, * represents a position at which Z¹ is bonded to L²¹ (when L²¹ represents a single bond, Z¹ is directly bonded to A).

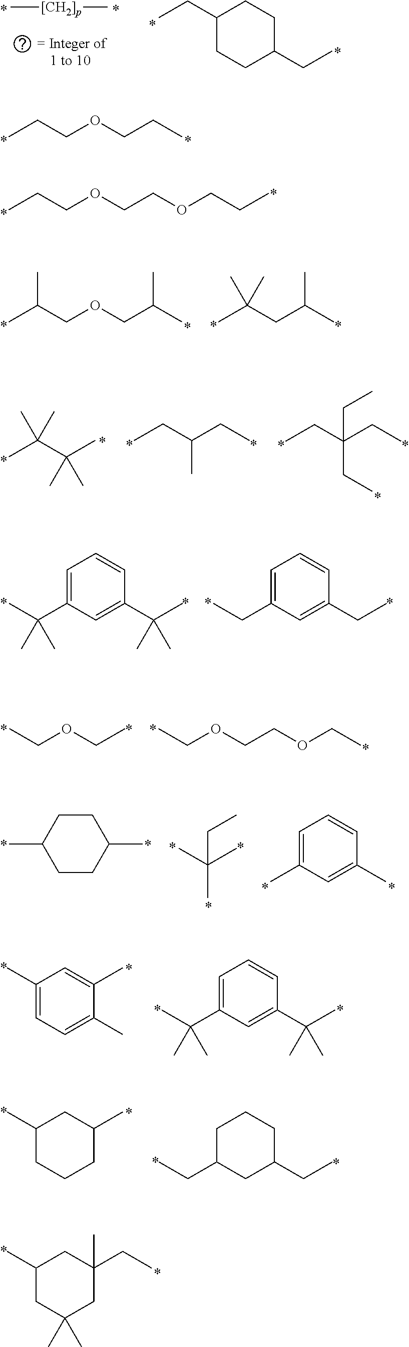

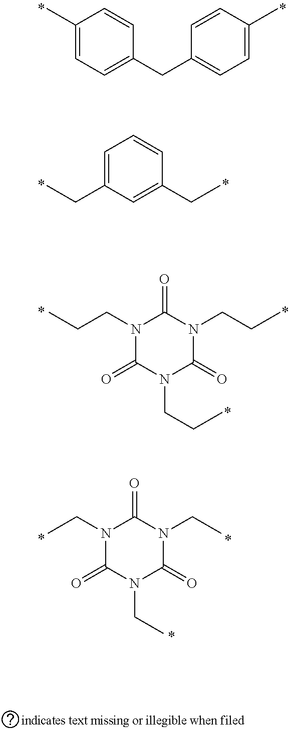

In one aspect, it is preferable that Z¹ has a ring structure, and it is more preferable that Z¹ is a group including at least one of a cyclic aliphatic group and an aromatic group. A cyclohexane ring which may have a substituent group and a benzene ring which may have a substituent group, or a group in which the cyclohexane ring is bonded to the benzene ring through a connecting group (preferably an alkylene group having 1 to 3 carbon atoms) are preferable as the ring structure included in Z¹. More preferably, the ring structure included in Z¹ is a cyclohexylene group which may have a substituent group or a phenylene group which may have a substituent group, or a xylylene group which may have a substituent group. Even more preferably, the ring structure included in Z¹ is a cyclohexane ring having one or more selected from a group consisting of an alkyl group having 1 to 3 carbon atoms, a bivalent connecting group denoted by —NH—(C═O)—O—, and a bivalent connecting group denoted by —NH—(C═O)—NR— as a substituent group, or a benzene ring having one or more selected from a group consisting of an alkyl group having 1 to 3 carbon atoms, a bivalent connecting group denoted by —NH—(C═O)—O—, and a bivalent connecting group denoted by —NH—(C═O)—NR— as a substituent group. In such an aspect, it is preferable that any one or both of both terminal groups of the compound denoted by Formula A-1 has a ring structure, and it is also preferable that any one or both of both terminal groups of the compound denoted by Formula A-1 does not have a ring structure.

In addition, in another aspect, Z¹ is preferably a straight-chain aliphatic group, and is more preferably an alkylene group, and it is more preferable that Z¹ is an alkylene group, and at least one of the both terminal groups of the compound denoted by Formula A-1 does not have a ring structure, and it is even more preferable that Z¹ is an alkylene group, and any one of the both terminal groups of the compound denoted by Formula A-1 does not have a ring structure.

Preferred aspects of the compound denoted by Formula A-1 are able to include a compound denoted by Formula A-2 described below.

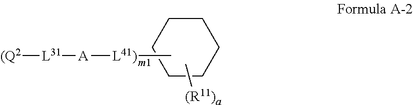

In Formula A-2, Q² represents a substituent group, L³¹ and L⁴¹ each independently represent a single bond, or any one of an alkylene group, an arylene group, —O—, —NR¹—, —S—, and —C(═O)— or a group formed of a combination of two or more types thereof. R¹ represents a hydrogen atom or a substituent group. A represents a single bond, *—X—C(═O)—NH—, or *—NH—C(═O)—X—, and * represents a bonding position with respect to L⁴¹. R¹¹ represents an alkyl group having 1 to 3 carbon atoms. a represents an integer in a range of 0 to 10, and when a is greater than or equal to 1, a plurality of R¹¹s may be identical to each other or different from each other. m1 represents 2 or 3, and a plurality of Q²s, L³¹s, L⁴¹s, and As may be identical to each other or different from each other, respectively. Here, at least one A represents *—X—C(═O)—NH— or *—NH—C(═O)—X—. At least one of the plurality of Q²s represents the polar group described above or the terminal group included in the polar group described above. When A represents *—NH—C(═O)—X—, X represents —NR—, L³¹ represents a single bond, and Q² has a ring structure, the ring structure included in Q² may be a ring structure formed along with R of —NR—.

Q² represents a substituent group, and at least one of the plurality of Q²s represents the polar group described above. Q² is identical to Q¹ of Formula A-1, and a preferred range is also identical to that of Q¹ of Formula A-1.

L³¹ and L⁴¹ are each independently identical to L¹¹ and L²¹ of Formula A-1, preferred ranges are also identical to those of L¹¹ and L²¹ of Formula A-1.

R¹¹ represents an alkyl group having 1 to 3 carbon atoms, and examples of R¹¹ include a methyl group, an ethyl group, a 1-propyl group, a 2-propyl group, and the like. R¹¹ is preferably a methyl group.

m1 represents 2 or 3, and is preferably 2. a represents an integer of 0 to 10, is preferably 0 to 5, is more preferably 0 to 3, and is even more preferably 1 to 3.

Specific examples of a bonding position 2 or 3 side chains in the cyclohexane ring of Formula (A-2) are as follows.

* described below is a position at which the side chain is bonded to

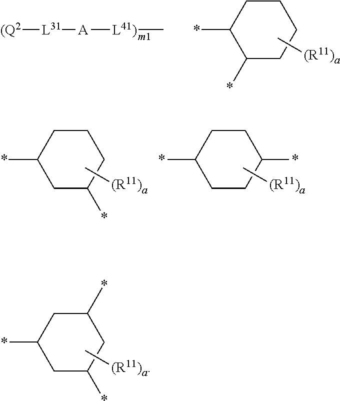

Preferred aspects of the compound denoted by Formula A-1 are able to include a compound denoted by Formula (A-3) described below.

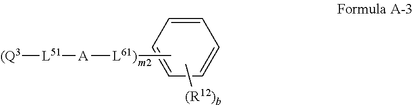

In Formula A-3, Q³ represents a substituent group, and L⁵¹ and L⁶¹ each independently represent a single bond, or any one of an alkylene group, —O—, —NR¹—, —S—, and —C(═O)—, or a group formed of a combination of two or more types thereof. R¹ represents a hydrogen atom or a substituent group. A represents a single bond, *—X—C(═O)—NH—, or *—NH—C(═O)—X—, and * represents a bonding position with respect to L⁶¹. R¹² represents an alkyl group having 1 to 3 carbon atoms, and b represents an integer in a range of 0 to 5. When b is an integer of greater than or equal to 1, a plurality of R¹²s may be identical to each other or different from each other. m2 represents 2 or 3, and a plurality of Q³s, L⁵¹s, L⁶¹s, and As may be identical to each other or different from each other, respectively. Here, at least one of the plurality of As represents *—X—C(═O)—NH— or *—NH—C(═O)—X—, and at least one of the plurality of Q³s represents the polar group described above or the terminal group included in the polar group described above.

Q³ represents a substituent group, and at least one of the plurality of Q³s includes the polar group described above. Q³ is identical to Q¹ of Formula A-1, and a preferred range is also identical to that of Q¹ of Formula A-1.

L⁵¹ and L⁶¹ are each independently identical to L¹¹ and L²¹ of Formula A-1, preferred ranges are also identical to those of L¹¹ and L²¹ of Formula A-1.

R¹² represents an alkyl group having 1 to 3 carbon atoms, and examples of the alkyl group include a methyl group, an ethyl group, a 1-propyl group, a 2-propyl group, and the like. R¹² is preferably a methyl group.

m2 represents 2 or 3, and is preferably 2. b represents an integer of 0 to 5, is more preferably 0 to 3, and is particularly preferably 0.

Specific examples of a bonding position of 2 or 3 side chains in a benzene ring of Formula A-3 are as follows.

* described below is a position at which the side chain is bonded to

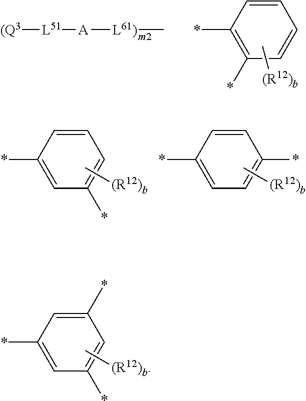

Preferred aspects of the compound denoted by Formula A-2 are able to include a compound denoted by Formula A-4 described below, and preferred aspects of the compound denoted by Formula A-3 are able to include a compound denoted by Formula A-5 described below.

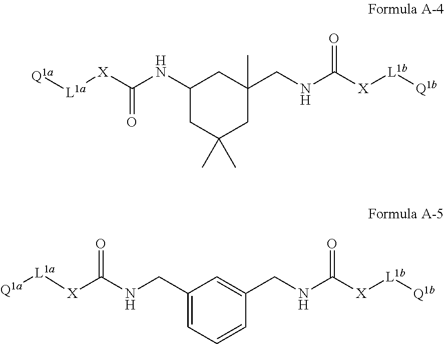

In Formulas A-4 and A-5, L^{1a} and L^{1b} each independently represent a single bond, or any one of an alkylene group, an arylene group, —O—, and —C(—O)— or a group formed of a compound of two or more thereof. X represents —O— or —NR—, and R represents a hydrogen atom or a substituent group. A plurality of Xs may be identical to each other or different from each other. Q^{1a} and Q^{1b} each independently represent a cyano group, a hydroxyl group, a succinimide group, a hexahydrophthalimide group, a methoxy carbonyl group, an alkoxy carbonyl amino group, an alkyl aminocarbonyl oxy group, an alkyl aminocarbonyl amino group, an alkyl group, a phenyl group, or a benzyl group, or represents a morpholino group formed along with R of —NR— when adjacent L^{1a} or L^{1b} represents a single bond, and X represents —NR—. Here, at least one of Q^{1a} and Q^{1b} represents the polar group described above, or the terminal group included in the polar group described above.

L^{1a} and L^{1b} each independently represent a single bond, or any one of an alkylene group, an arylene group, —O—, and —C(═O)—, or a group formed of a combination of two or more thereof. The alkylene group is identical to the alkylene group described in L¹ and L² of Formula A described above. In addition, in the group represented by L^{1a} and L^{1b}, the number of carbon atoms in a main chain portion is preferably in a range of 1 to 10, and is more preferably in a range of 1 to 5.

Q^{1a} and Q^{1b} each independently represent a cyano group, a hydroxyl group, a succinimide group, a hexahydrophthalimide group, a methoxy carbonyl group, an alkoxy carbonyl amino group, an alkyl aminocarbonyl oxy group, an alkyl aminocarbonyl amino group, an alkyl group, a phenyl group, or a benzyl group, or represent the morpholino group described above. Here, at least one of Q^{1a} and Q^{1b} represents the polar group described above or the terminal group included in the polar group described above. Preferred combinations of Q^{1a} and Q^{1b} are able to include combinations described below.

(Combination 1) Cyano Group and Cyano Group

(Combination 2) Succinimide Group and Succinimide Group

(Combination 3) Hexahydrophthalimide Group and Hexahydrophthalimide Group

(Combination 4) Cyano Group and Phenyl Group

(Combination 5) Methoxy Carbonyl Group and Phenyl Group

(Combination 6) Hydroxyl Group and Hydroxyl Group

(Combination 7) Morpholino Group and Cyano Group

(Combination 8) Alkoxy Carbonyl Amino Group and Alkoxy Carbonyl Amino Group

(Combination 9) Alkoxy Carbonyl Amino Group and Aminocarbonyl Oxy Group

(Combination 10) Alkoxy Carbonyl Amino Group and Alkyl Group

(Combination 11) Aminocarbonyl Oxy Group and Alkyl Group

X is identical to X of Formula A-1, and a preferred range is also identical to that of X of Formula A-1.

Examples of the preferred aspect of the compound denoted by Formula A-4 are able to include a compound denoted by Formula A-6 described below, and examples of the preferred aspect of the compound denoted by Formula A-5 are able to include a compound denoted by Formula A-7 described below and a compound denoted by Formula A-8 described below.

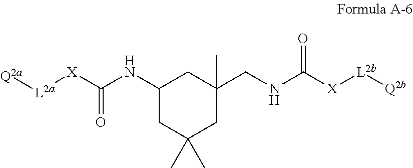

In Formula A-6, Q^{2a} and Q^{2b} each independently represent a cyano group, a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, a 2-propyl aminocarbonyl oxy group, an alkyl group, a phenyl group, or a benzyl group, and at least one of Q^{2a} and Q^{2b} represents a cyano group, a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, or a 2-propyl aminocarbonyl oxy group. Preferably, both of Q^{2a} and Q^{2b} represent a cyano group. L^{2a} and L^{2b} each independently represent a single bond, or any one of an alkylene group, an arylene group, —O—, and —C(═O)— or a group formed of a combination of two or more thereof. X represents —O— or —NR¹—, and R¹ represents a hydrogen atom or a substituent group. A plurality of Xs may be identical to each other or different from each other.

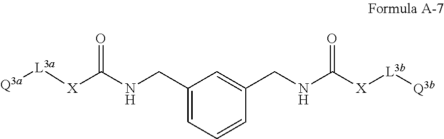

In Formula A-7, any one of Q^{3a} and Q^{3a} represents a cyano group, a succinimide group, or a hexahydrophthalimide group, and the other represents an alkyl group, a phenyl group, or a benzyl group.

In a preferred aspect, any one of Q^{3a} and Q^{3b} represents a cyano group, and the other represents a phenyl group.

In addition, in another aspect, it is preferable that in the compound denoted by Formula A-7, both of Q^{3a} and Q^{3b} do not include a cyano group. For example, when any one of Q^{3a} and Q^{3b} is a cyano group substituted alkyl group, it is preferable that the other is a succinimide group or a hexahydrophthalimide group. In addition, when any one of Q^{3a} and Q^{3b} is a cyano group, it is preferable that the other is a phenyl group or a benzyl group.

In one aspect, the alkyl group described above is a non-substitutional alkyl group, and in another aspect, the alkyl group described above is a substitutional alkyl group. Examples of the substitutional alkyl group are able to include an aryl carbonyl alkyl group such as a benzoyl alkyl group, an aryl oxy alkyl group such as a phenyl oxy alkyl group, and the like.

L^{3a} and L^{3b} each independently represent a single bond, or any one of an alkylene group, an arylene group, —O—, and —C(═O)— or a group formed of a combination of two or more thereof. X represents —O— or —NR—, R represents a hydrogen atom or a substituent group; and a plurality of Xs may be identical to each other or different from each other.

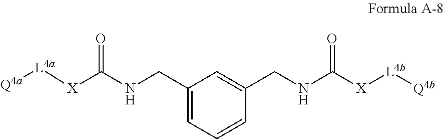

In Formula A-8, Q^{4a} and Q^{4b} each independently represent a methoxy carbonyl amino group, an ethoxy carbonyl amino group, a 1-propoxy carbonyl amino group, a 2-propoxy carbonyl amino group, methyl aminocarbonyl oxy group, an ethyl aminocarbonyl oxy group, a 1-propyl aminocarbonyl oxy group, a 2-propyl aminocarbonyl oxy group, alkyl group, a phenyl group, or a benzyl group, and at least one of Q^{4a} and Q^{4b} represents a methoxy carbonyl amino group, an ethoxy carbonyl amino group, a 1-propoxy carbonyl amino group, a 2-propoxy carbonyl amino group, a methyl aminocarbonyl oxy group, an ethyl aminocarbonyl oxy group, a 1-propyl aminocarbonyl oxy group, or a 2-propyl aninocarbonyl oxy group. L^{4a} and L^{4b} each independently represent a single bond, or any one of an alkylene group, an arylene group, —O—, and —C(═O)— or a group formed of a combination of two or more thereof. X represents —O— or —NR—, and R represents a hydrogen atom or a substituent group. A plurality of Xs may be identical to each other or different from each other.

In Formulas A-6, A-7, and A-8, each of L^{2a}, L^{2b}, L^{3a}, L^{3b}, L^{4a}, and L^{4b} is identical to L^{1a} and L^{1b} of Formulas A-4 and A-5, and preferred ranges are also identical to those of L^{1a} and L^{1b} of Formulas A-4 and A-5.

In Formulas A-6, A-7, and A-8, X is identical to X of Formula A-1, and a preferred range is also identical to X of Formula A-1.

In addition, examples of the preferred aspect of the compound denoted by Formula A-1 are able to include a compound denoted by Formula A-9 described below.

Q¹⁰⁰-(L¹⁰⁰-A¹⁰⁰)m1-Q¹⁰¹ Formula A-9:

In Formula A-9, L¹⁰⁰ represents any one of a single bond, an alkylene group, and

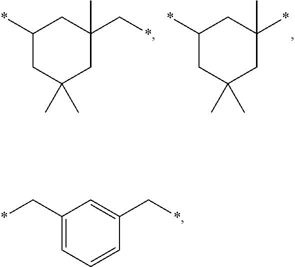

and * represents a bonding position with respect to the other structure configuring the compound denoted by Formula A-9. One or more of a plurality of L¹⁰⁰s represent a group other than a single bond. Q¹⁰⁰ and Q¹⁰¹ each independently represent an alkyl group, a hydroxyl group, or a cyano group. A¹⁰⁰ represents *—X—C(═O)—NH— or *—NH—C(═O)—X—, and * represents a bonding position with respect to L¹⁰⁰. X represents —O— or —NR—, and R represents a hydrogen atom or a substituent group. m1 represents an integer in a range of 2 to 6.

A plurality of L¹⁰⁰s and A¹⁰⁰s may be identical to each other or different from each other, respectively.

In Formula A-9, the alkylene group represented by L¹⁰⁰ is identical to the alkylene group represented by L¹ and L² of Formula A described above.

In Formula A-9, the alkyl group represented by Q¹⁰⁰ and Q¹⁰¹ is an alkyl group having 1 to 3 carbon atoms.

In Formula A-9, X is identical to X of Formula A-1, and a preferred range is also identical to that of X of Formula A-1.

In the compound described above, the equivalent weight U obtained as U=[(Molecular Weight)/(Number of Connecting Groups Included in One Molecule, Which Are Selected from Group Consisting of Bivalent Connecting Group Denoted by NH—(C═O)—O— and Bivalent Connecting Group Denoted by —NH—(C═O)—NR— in Which R Represents Hydrogen Atom or Substituent Group)] is less than or equal to 515. A preferred range of the equivalent weight U is as described above.

Hereinafter, in the compound described above, the compound which is preferably used in the present invention is exemplified, but the present invention is not limited thereto.

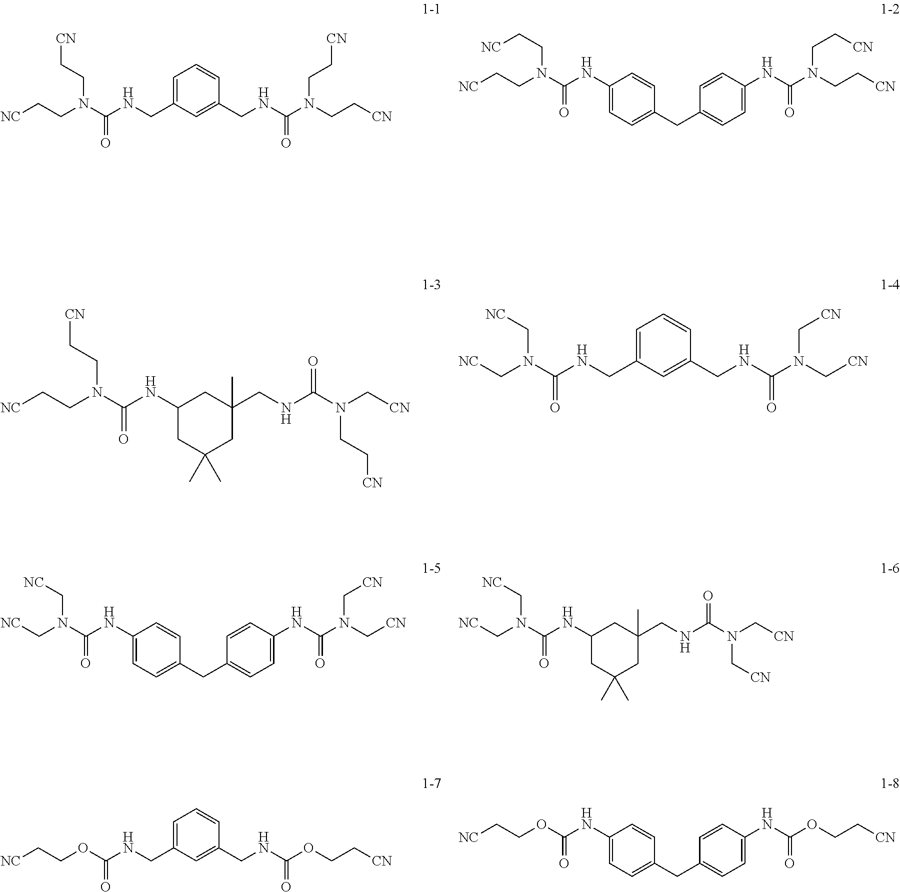

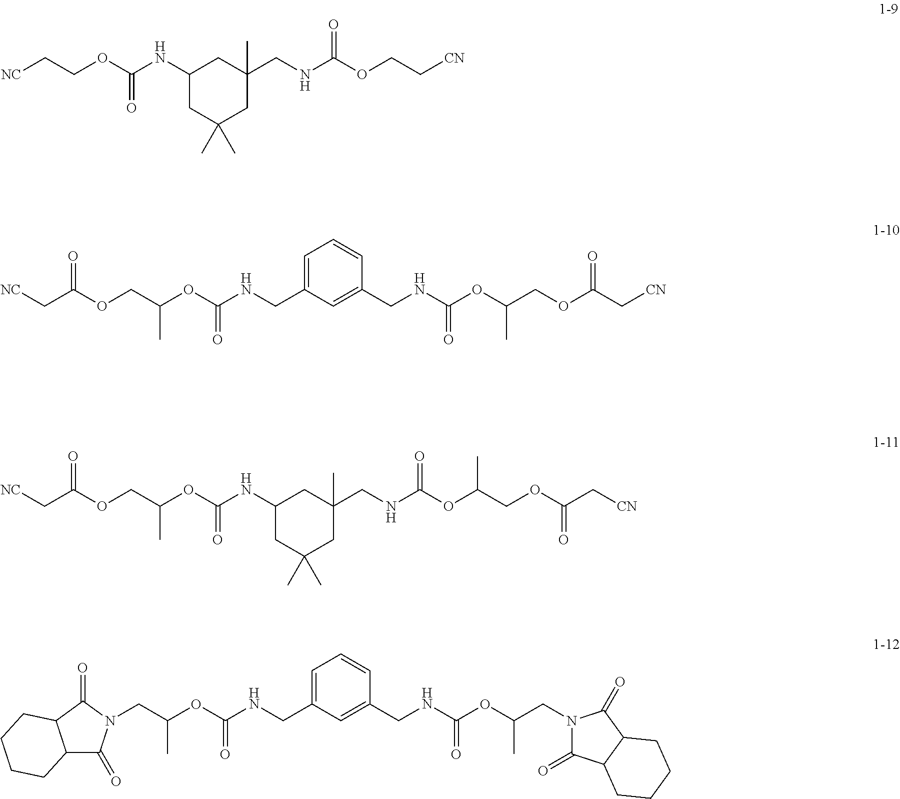 [SMILES: CC1(C)CC(NC(=O)OCCC#N)CC(C)(CNC(=O)OCCC#N)C1 ; CC(COC(=O)CC#N)OC(=O)NCc1cccc(CNC(=O)OC(C)COC(=O)CC#N)c1 ; CC(COC(=O)CC#N)OC(=O)NCC1(C)CC(NC(=O)OC(C)COC(=O)CC#N)CC(C)(C)C1 ; CC(CN1C(=O)C2CCCCC2C1=O)OC(=O)NCc1cccc(CNC(=O)OC(C)CN2C(=O)C3CCCCC3C2=O)c1]

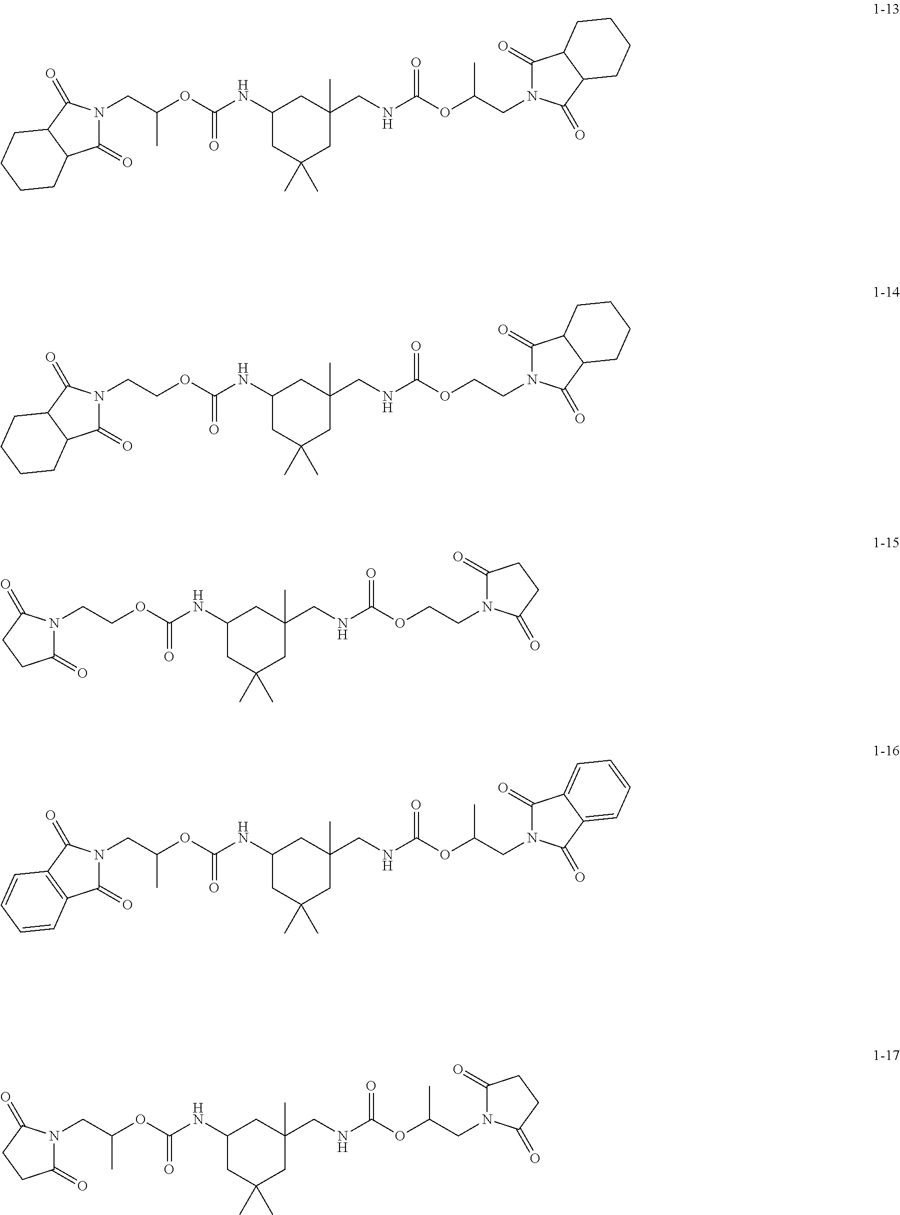 [SMILES: CC(CN1C(=O)C2CCCCC2C1=O)OC(=O)NCC1(C)CC(NC(=O)OC(C)CN2C(=O)C3CCCCC3C2=O)CC(C)(C)C1 ; CC1(C)CC(NC(=O)OCCN2C(=O)C3CCCCC3C2=O)CC(C)(CNC(=O)OCCN2C(=O)C3CCCCC3C2=O)C1 ; CC1(C)CC(NC(=O)OCCN2C(=O)CCC2=O)CC(C)(CNC(=O)OCCN2C(=O)CCC2=O)C1 ; CC(CN1C(=O)c2ccccc2C1=O)OC(=O)NCC1(C)CC(NC(=O)OC(C)CN2C(=O)c3ccccc3C2=O)CC(C)(C)C1 ; CC(CN1C(=O)CCC1=O)OC(=O)NCC1(C)CC(NC(=O)OC(C)CN2C(=O)CCC2=O)CC(C)(C)C1]

TABLE 1

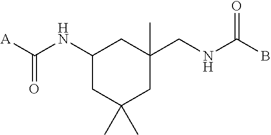

| Composition | | |
|---|---|---|
| Number | A | B |
| 2-1-A | *—OCH₂CH₂OPh | *—N(CH₃)CH₂COOCH₃ |
| 2-2-A | *—OCH₂CH₂OPh | *—N(CH₂CH₂CN)₂ |
| 2-3-A | *—OCH₂CH₂OPh | *—N(CH₂CN)₂ |
| 2-4-A | *—OCH₂CH₂CN | *—N(CH₂CH₂CN)₂ |
| 2-5-A | *—OCH₂CH₂CN | *—N(CH₂CN)₂ |
| 2-6-A | *—OCH₂CH₂OPh | *—OCH₂CH₂CN |
| 2-1-B | *—N(CH₃)CH₂COOCH₃ | *—OCH₂CH₂OPh |
| 2-2-B | *—N(CH₂CH₂CN)₂ | *—OCH₂CH₂OPh |
| 2-3-B | *—N(CH₂CN)₂ | *—OCH₂CH₂OPh |
| 2-4-B | *—N(CH₂CH₂CN)₂ | *—OCH₂CH₂CN |
| 2-5-B | *—N(CH₂CN)₂ | *—OCH₂CH₂CN |
| 2-6-B | *—OCH₂CH₂CN | *—OCH₂CH₂OPh |

In Table, Ph: Phenyl Group, and *Bonding Position)

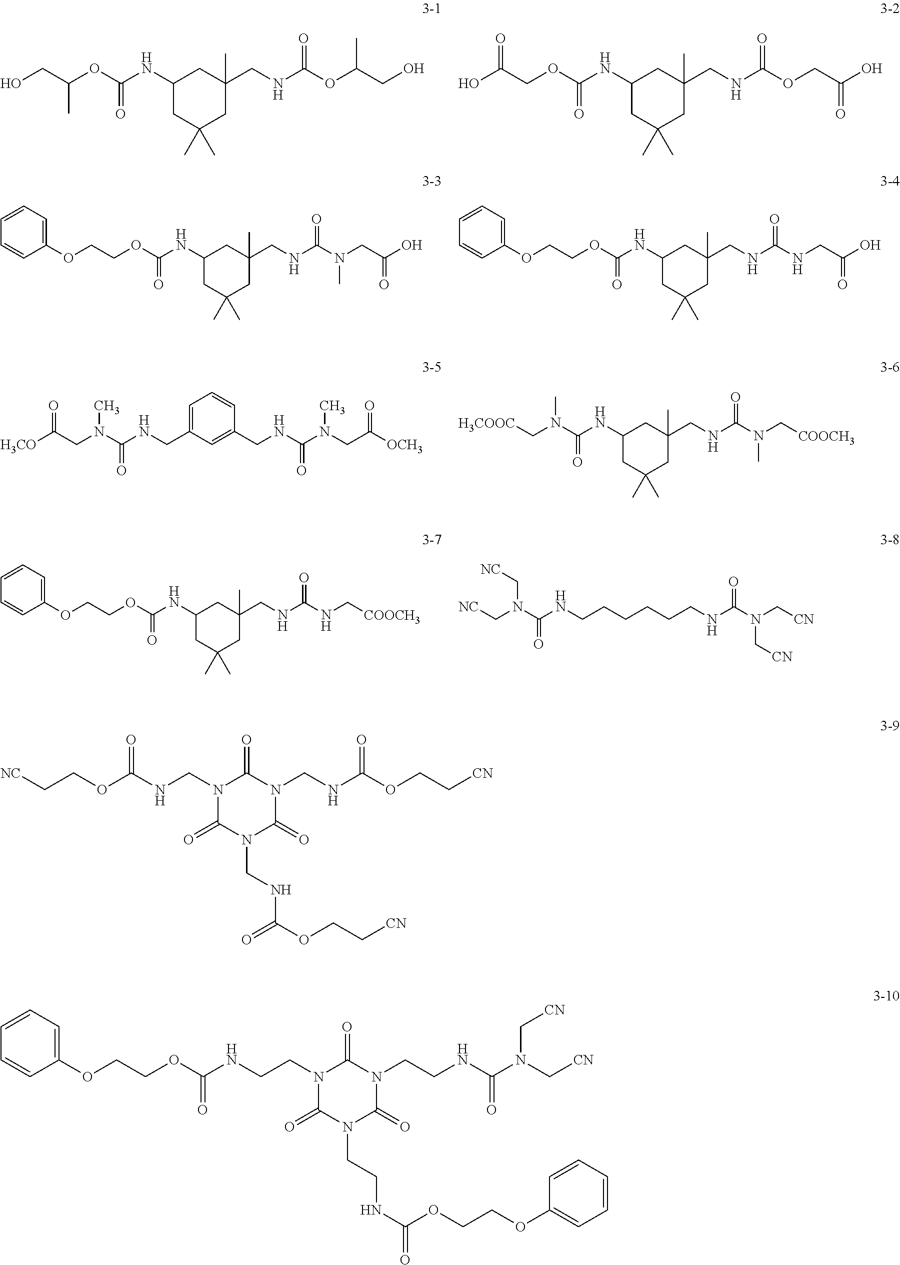

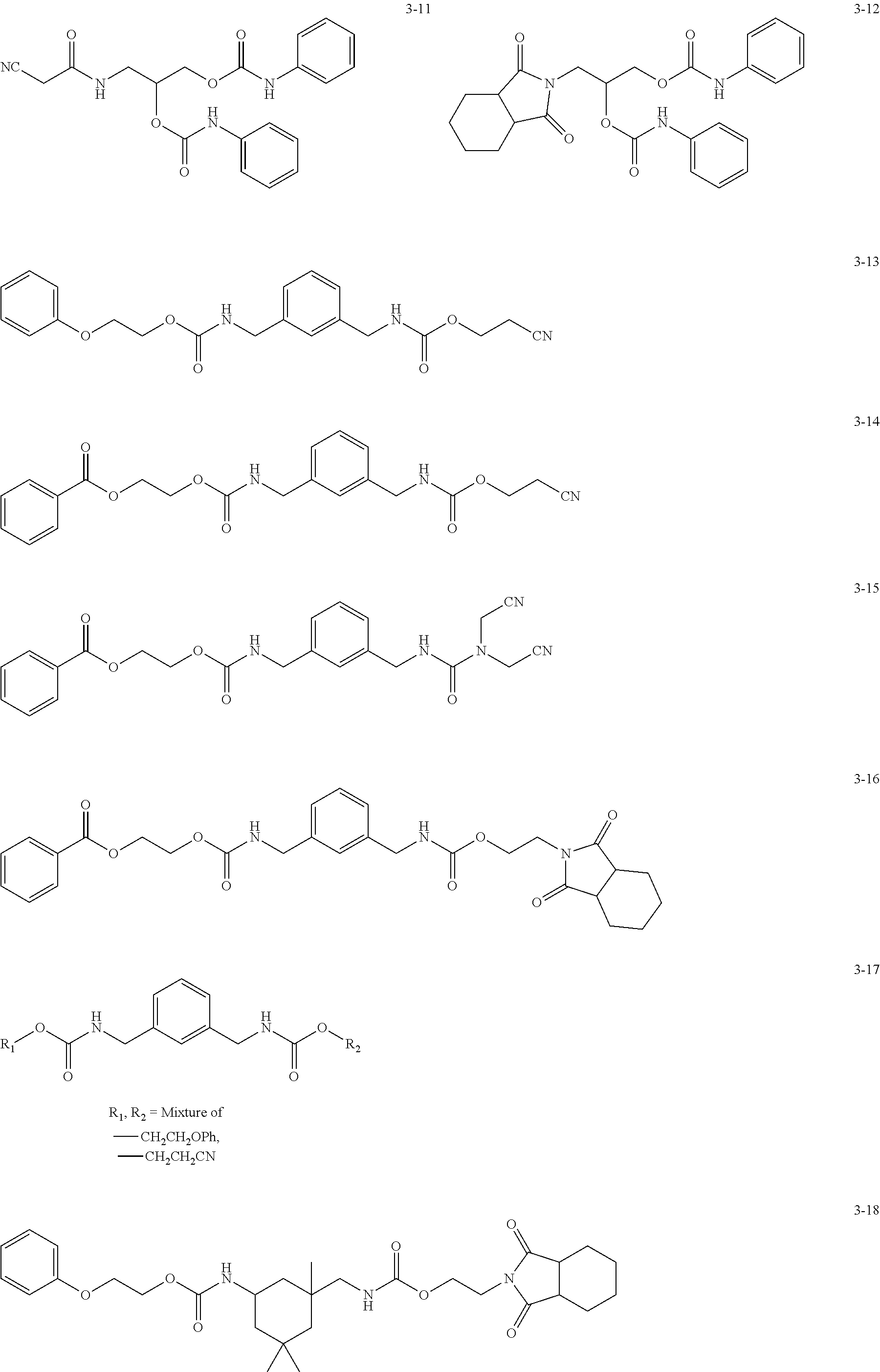

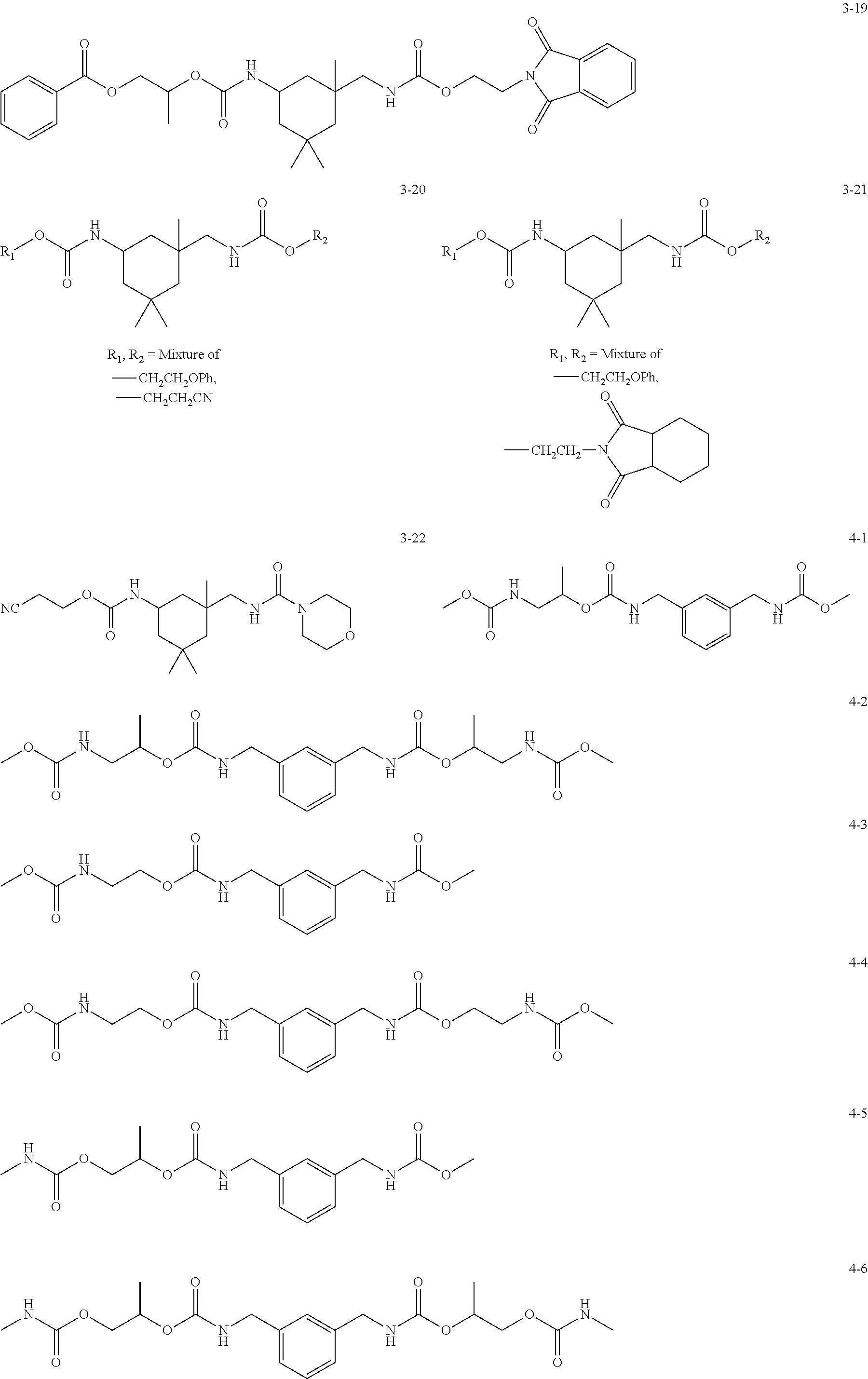

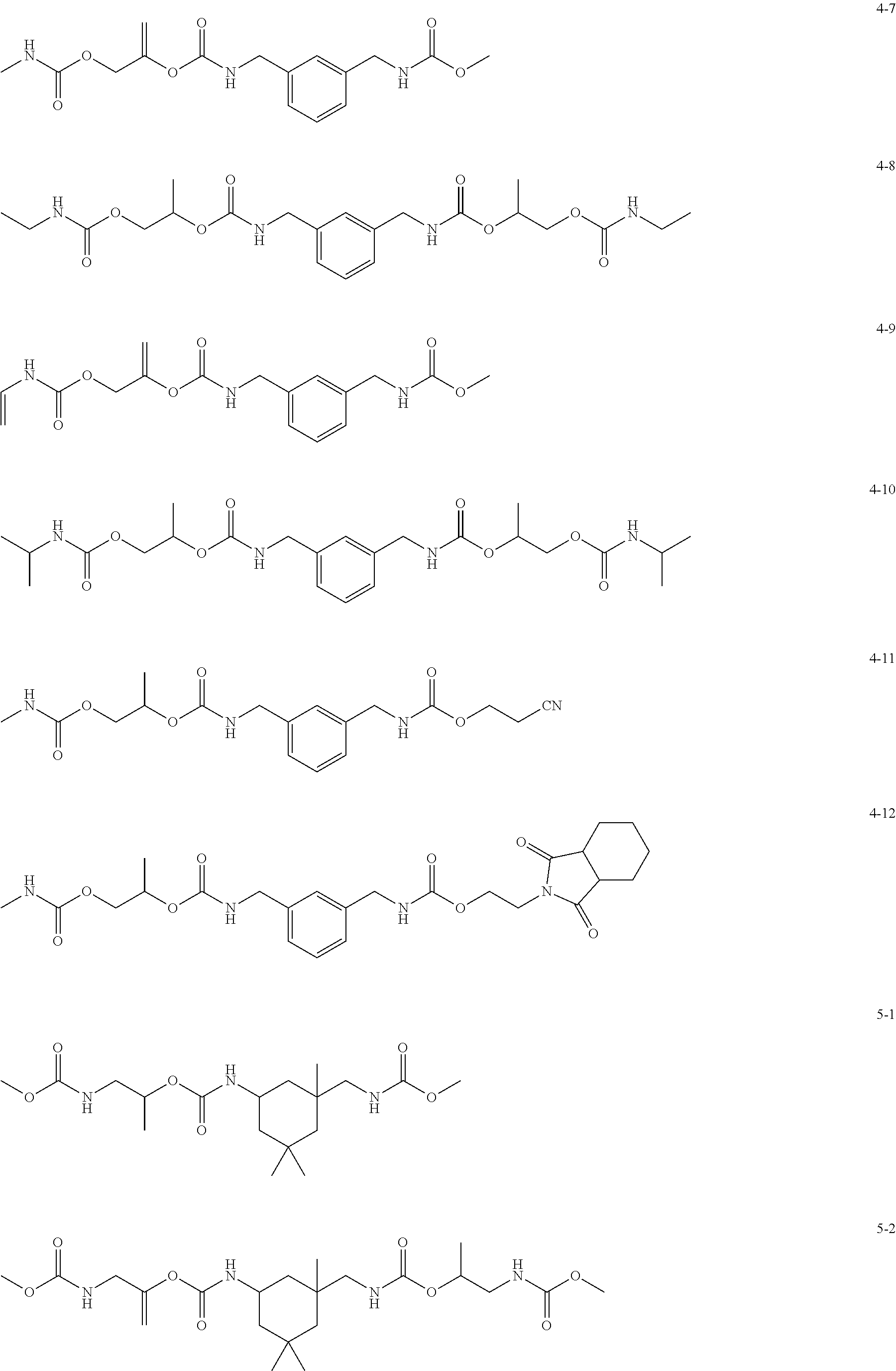

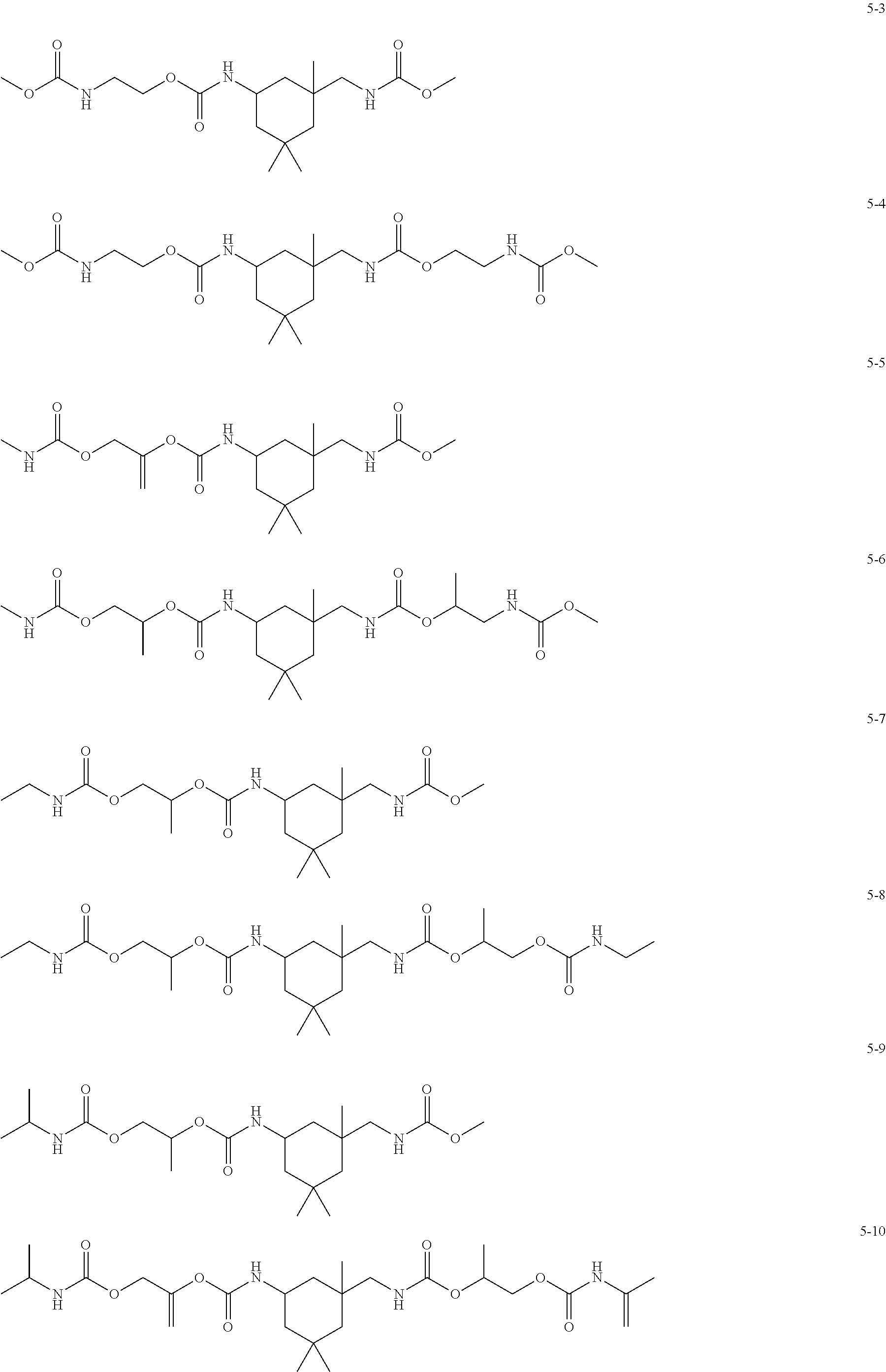

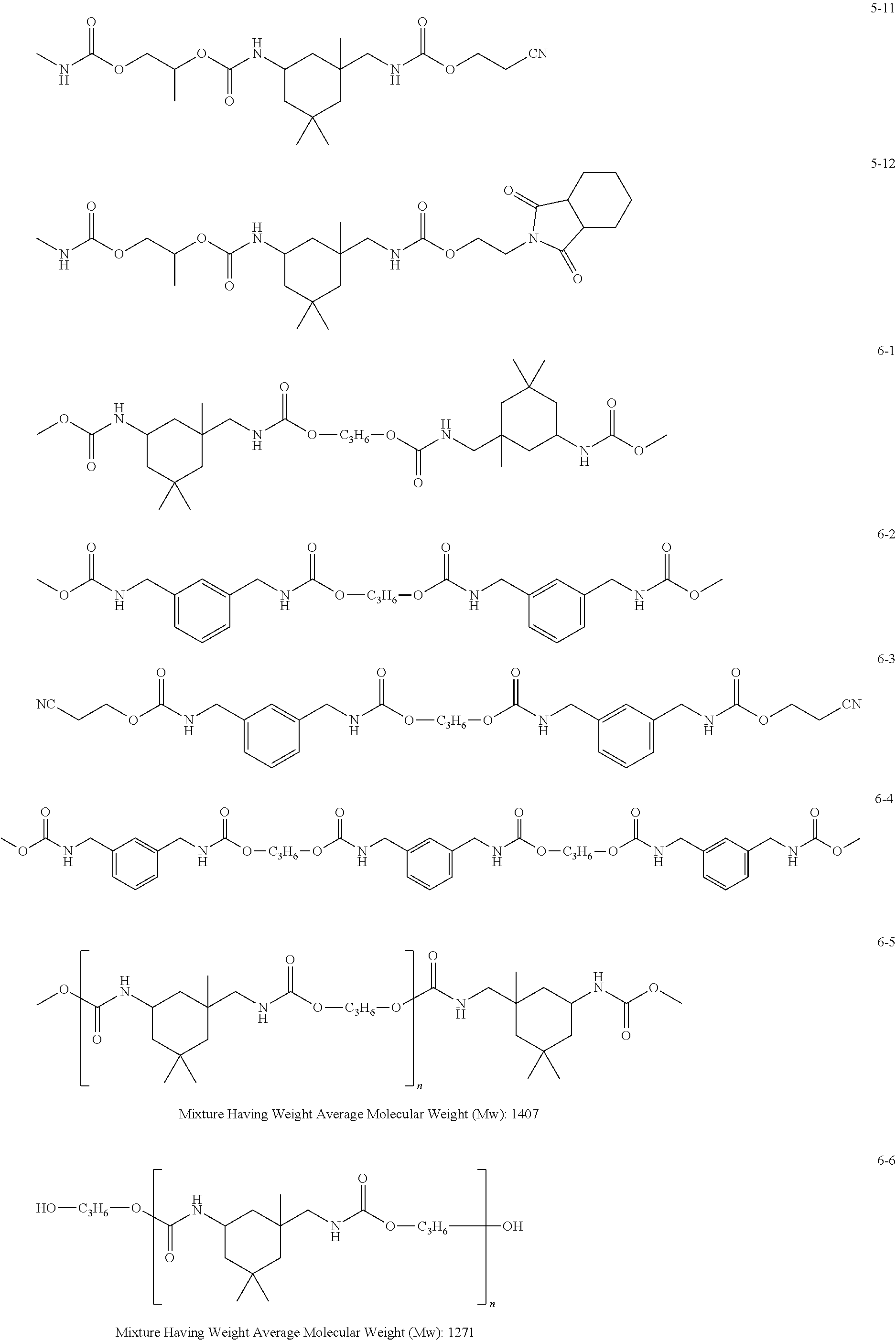

(In exemplary compounds 6-1 to 6-6, —C₃H₆— is —CH(CH₃)—CH₂— or —CH₂—CH(CH₃)—.)

The compound described above is able to be manufactured by a known method. For example, the compound described above is able to be obtained by an addition reaction, or the like, of alcohol or amine to alkyl or aryl isocyanate.

It is preferable that a catalyst is used at the time of performing the addition reaction of alcohol or amine to alkyl or aryl isocyanate, and a known urethanized catalyst of the related art such as amines, a salt of a metal organic acid or a metal chelate compound of zinc, tin, and the like, and an organic metal compound of zinc, tin, bismuth are able to be used as the catalyst.

For example, dibutyl tin dilaurate, dibutyl tin diacetate, and the like are preferably used as the urethanized catalyst.

Furthermore, when a component for introducing a bivalent connecting group denoted by —NH—(C═O)—O— and a component for introducing a bivalent connecting group denoted by —NH—(C═O)—NR— are used together at the time of synthesizing the compound described above, a structure including only one of the two connecting groups (a so-called symmetric structure) and a structure including both of the two connecting groups (a so-called asymmetric structure) are able to be obtained. In addition, a mixture of compounds each having different number of connecting groups described above to be included is able to be obtained as the asymmetric structure. In the present invention, the compound is able to be used for manufacturing a cellulose acylate film in a state of a mixture of the compound having a symmetric structure and a compound having an asymmetric structure or in a state of a mixture of the compounds each having different number of connecting groups described above to be included. Alternatively, a compound having a desired structure is able to be purified from the mixture by a known method, and is able to be used as a single item.

Any one of a combination of polyvalent isocyanate (diisocyanate, triisocyanate, and the like) and monohydric alcohol, a combination of polyhydric alcohol and monovalent isocyanate, a combination of polyvalent isocyanate (diisocyanate, triisocyanate, and the like) and monovalent amine, a combination of polyvalent amine and monovalent isocyanate, and a combination of aminoalcohol and monovalent isocyanate is able to be preferably used for synthesizing the compound described above.

Examples of a polyvalent isocyanate component include aliphatic diisocyanate such as ethylene diisocyanate, trimethylene diisocyanate, tetramethylene diisocyanate, hexamethylene diisocyanate, and isophorone diisocyanate, aromatic diisocyanate such as p-phenylene diisocyanate, tolylene diisocyanate, p,p′-diphenyl methane diisocyanate, and 1,5-naphthylene diisocyanate, m-xylylene diisocyanate, and the like, but the present invention is not limited thereto. Among them, from viewpoint of suppressing photo-coloration, the aliphatic diisocyanate and the m-xylylene diisocyanate in which a conjugated system is cut are preferable.

Examples of a monovalent isocyanate component include phenyl isocyanate, benzyl isocyanate, butyl isocyanate, and the like, but the present invention is not limited thereto.

Examples of the polyhydric alcohol are able to include ethylene glycol, diethylene glycol, triethylene glycol, tetraethylene glycol, 1,2-propane diol, 1,3-propane diol, dipropylene glycol, tripropylene glycol, 1,3-butane diol, 1,4-butane diol, 1,5-pentane diol, 1,6-hexane diol, trimethylol propane, trimethylol ethane, glycerin, and the like.

Examples of the monohydric alcohol include cyano ethanol, 2-hydroxyl ethyl succinimide, 2-hydroxyl ethyl phthalimide, and the like. In addition, an alcohol component having an aromatic ring is preferable as an alcohol component, and examples of the alcohol component having an aromatic ring include benzyl alcohol, phenethyl alcohol, phenoxy ethanol, and the like.

Examples of the polyvalent amine are able to include ethylene diamine, xylylene diamine, 4,4′-diaminodiphenyl methane, and the like.

Examples of the monovalent amine include imino diacetonitrile, imino dipropionitrile, glycine, N-methyl glycine, and the like. In addition, benzyl amine, cyclohexyl amine, morpholine, piperidine, and the like are able to be used as the monovalent amine.

Examples of the aminoalcohol include 2-aminoethanol, 1-amino-2-propanol, and the like.

The degree of hydrophilicity of the entire compound described above is able to be denoted by a C log P value. C log P is as described above. C log P of the compound described above is preferably −1.0 to 12.0, is more preferably 0.0 to 10.0, and is even more preferably 1.0 to 8.0.

In addition, the melting point of the compound described above is preferably −50° C. to 250° C., and is more preferably −30° C. to 200° C. According to such a range, the effects of the present invention tend to be more effectively expressed.

A measurement method of the melting point is not particularly limited, but is able to be suitably selected from known methods, and examples of the measurement method include a measurement method using a trace melting point measure device and the like.

(Cellulose Acylate)

A degree of substitution of the cellulose acylate indicates a ratio in which three hydroxyl groups existing in a constituent unit of cellulose (glucose having a (β)1,4-glycoside bond) are acylated. The degree of substitution (a degree of acylation) is able to be calculated by measuring the amount of bonded fatty acid per constituent unit mass of cellulose. In the present invention, a degree of substitution of a cellulose body is able to be calculated by dissolving the cellulose body in a solvent such as dimethyl sulfoxide which is subjected to deuterium substitution, by measuring a ¹³C-NMR spectrum, and by obtaining the degree of substitution from a peak intensity ratio of carbonyl carbon in an acyl group. A residual hydroxyl group of the cellulose acylate is able to be substituted with other acyl groups which are different from the acyl group of the cellulose acylate itself, and then the degree of substitution is able to be obtained by ¹³C-NMR measurement. The details of a measurement method are disclosed in (Carbohydrate. Res., 273 (1995) 83-91) of TEZUKA et al.

The degree of substitution of the cellulose acylate used in the present invention is preferably greater than or equal to 1.5 and less than or equal to 3.0, is more preferably 2.00 to 2.97, is even more preferably greater than or equal to 2.50 and less than 2.97, and is particularly preferably 2.70 to 2.95.

In addition, in cellulose acetate using only an acetyl group as the acyl group of the cellulose acylate, the degree of substitution is preferably greater than or equal to 2.0 and less than or equal to 3.0, is more preferably 2.3 to 3.0, is even more preferably 2.60 to 3.0, is still more preferably 2.6 to 2.97, and is particularly preferably 2.70 to 2.95, from a viewpoint of a great surface hardness enhancement effect due to the compound described above.

An acetyl group, a propionyl group, and a butyryl group are particularly preferable, and the acetyl group is more particularly preferable as the acyl group of the cellulose acylate which is able to be used in the present invention.

In the present invention, mixed fatty acid ester formed of two or more types of acyl groups is also able to be preferably used as the cellulose acylate. Even in this case, an acetyl group and an acyl group having 3 to 4 carbon atoms are preferable as the acyl group. In addition, when the mixed fatty acid ester is used, the degree of substitution at the time of including the acetyl group as the acyl group is preferably less than 2.5, and is more preferably less than 1.9. On the other hand, the degree of substitution at the time of including the acyl group having 3 to 4 carbon atoms is preferably 0.1 to 1.5, is more preferably 0.2 to 1.2, and is particularly preferably 0.5 to 1.1.

In the present invention, two types of cellulose acylates having different substituent groups and/or degrees of substitution may be used together or may be used by being mixed, and a film formed of a plurality of layers consisting of different cellulose acylates may be formed by a cocasting method or the like described below.

Further, mixed acid ester having a fatty acid acyl group and a substitutional aromatic acyl group or a non-substitutional aromatic acyl group disclosed in paragraphs 0023 to 0038 of JP2008-20896A is also able to be preferably used in the present invention.

It is preferable that the cellulose acylate used in the present invention has a mass average degree of polymerization of 250 to 800, and it is more preferable that the cellulose acylate used in the present invention has a mass average degree of polymerization of 300 to 600. In addition, it is preferable that the cellulose acylate used in the present invention has a number average molecular weight of 40000 to 230000, it is more preferable that the cellulose acylate used in the present invention has a number average molecular weight of 60000 to 230000, and it is most preferable that the cellulose acylate used in the present invention has a number average molecular weight of 75000 to 200000.

The cellulose acylate used in the present invention is able to be synthesized by using an acid anhydride or an acid chloride as an acylation agent. When the acylation agent is the acid anhydride, an organic acid (for example, an acetic acid) or methylene chloride is used as a reaction solvent. In addition, a protonic catalyst such as a sulfuric acid is able to be used as a catalyst. When the acylation agent is the acid chloride, a basic compound is able to be used as a catalyst. In the most general industrial synthesis method, cellulose is esterified by a mixed organic acid component including an organic acid (an acetic acid, a propionic acid, and a butyric acid) corresponding to an acetyl group and other acyl groups or an acid anhydride thereof (acetic anhydride, propionic anhydride, and butyric anhydride), and thus cellulose acylate is synthesized.

In the method described above, in general, cellulose such as cotton linter or wood pulp is subjected to an activation treatment by an organic acid such as an acetic acid, and then is esterified by using a mixed liquid of the organic acid component as described above in the presence of a sulfuric acid catalyst. In general, an excessive amount of organic acid anhydride component is used with respect to the amount of hydroxyl group in the cellulose. In this esterification treatment, a hydrolysis reaction (a depolymerization reaction) of a cellulose main chain (a (β)1,4-glycoside bond) progresses in addition to an esterification reaction. When the hydrolysis reaction of the main chain progresses, the degree of polymerization of the cellulose acylate decreases, and physical properties of a cellulose acylate film to be manufactured, decrease. For this reason, it is preferable that reaction conditions such as a reaction temperature are determined in consideration of the degree of polymerization or the molecular weight of cellulose acylate to be obtained.

Added Amount

The added amount of the compound denoted by Formula A is not particularly limited, but is preferably 1 part by mass to 50 parts by mass, is more preferably 2 parts by mass to 30 parts by mass, is even more preferably 2 parts by mass to 20 parts by mass, and is particularly preferably 4 parts by mass to 15 parts by mass, with respect to 100 parts by mass of cellulose acylate. Furthermore, two or more types of compounds described above may be added. Even when two or more types of compounds are added, a specific example and a preferred range of the added amount are as described above.

The cellulose acylate film of the present invention may contain other additives in addition to the cellulose acylate and the compound described above. A known plasticizer, an organic acid, a dye, a polymer, a retardation adjusting agent, a ultraviolet absorbent, an antioxidant, a matting agent, and the like are exemplified as the additives. The additives are able to refer to additives disclosed in paragraphs 0062 to 0097 of JP2012-155287A, and the contents are incorporated herein. The total blended amount of the additives is preferably less than or equal to 50 mass %, and is more preferably less than or equal to 30 mass %, with respect to cellulose acylate.

<Manufacturing Method of Cellulose Acylate Film>

A manufacturing method of the cellulose acylate film of the present invention is not particularly limited, but it is preferable that the cellulose acylate film of the present invention is manufactured by a melting film formation method or a solution film formation method (a solvent casting method), and it is more preferable that the cellulose acylate film of the present invention is manufactured by a solution film formation method (a solvent casting method). A manufacturing example of a cellulose acylate film using the solvent casting method is able to refer to each specification of U.S. Pat. No. 2,336,310A, U.S. Pat. No. 2,367,603A, U.S. Pat. No. 2,492,078A, U.S. Pat. No. 2,492,977A, U.S. Pat. No. 2,492,978A, U.S. Pat. No. 2,607,704A, U.S. Pat. No. 2,739,069A, and U.S. Pat. No. 2,739,070A, each specification of GB640731A and GB736892A, and each publication of JP1970-4554B (JP-S45-4554B), JP1974-5614B (JP-S49-5614B), JP1985-176834A (JP-S60-176834A), JP1985-203430A (JP-S60-203430A), JP1987-115035A (JP-S62-115035A), and the like. In addition, the cellulose acylate film may be subjected to a stretching treatment. A method and conditions of the stretching treatment, for example, are able to refer to each publication of JP1987-115035A (JP-S62-115035A), JP1992-152125A (JP-H04-152125A), JP1992-284211A (JP-H04-284211A), JP 1992-298310A (JP-H04-29831 OA), JP1999-48271 A (JP-H11-48271A), and the like.

(Casting Method)

Examples of the solution casting method include a method in which a prepared dope is homogeneously extruded onto a metal support body from a pressure die, a doctor blade method in which the film thickness of a dope which has been casted on a metal support body is adjusted by using a blade, a reverse roll coater method in which the film thickness is adjusted by using a reversely rotating roll, and the like, and the pressure die method is preferable. A coat hanger type die, a T die type die, or the like is used as the pressure die, and all of the dies are able to be preferably used. In addition, a cellulose acylate solution is able to be casted by using various methods which have been known from the related art in which a cellulose acylate solution is casted and a film is formed in addition to the methods described herein, and each condition is set in consideration of a difference in a boiling point of a solvent to be used, or the like.

Cocasting

In the formation of the cellulose acylate film, a lamination casting method such as a cocasting method, a sequentially casting method, and a coating method is preferably used, and a concurrently cocasting method is particularly preferably used from a viewpoint of stable manufacturing and a reduction in production costs.

When the cellulose acylate film is manufactured by using the cocasting method and the sequentially casting method, first, the cellulose acetate solution (the dope) for each layer is prepared. The cocasting method (multi-layer concurrently casting) is a casting method in which the dope is extruded from a die for casting concurrently extruding a dope for casting of each of the layers (three layers or three or more layers may be used) from a separate slit or the like onto a support body for casting (a band or a drum), the respective layers are concurrently casted, are peeled off from the support body at a suitable timing, and are dried, and thus a film is molded. It is possible to concurrently extrude and cast a dope for a surface layer and a dope for a core layer on the support for casting in three layers by using an extrusion cocasting die.

The sequentially casting method is a casting method in which, first, a dope for casting of a first layer is extruded from the die for casting onto the support body for casting, is casted, and is dried or is not dried, and a dope for casting of a second layer is extruded from the die for casting of the second layer and is casted, and in this manner, as necessary, dopes for third or more layers are sequentially casted and laminated, and then the dopes are peeled off from the support body at a suitable timing and are dried, and thus a cellulose acylate film is molded. In general, the coating method is a method in which a core layer is molded into the shape of a film by using a solution film formation method, a coating liquid applied onto a surface layer is prepared, the coating liquid is applied onto each one surface or is concurrently applied onto both surfaces of the core layer and is dried by using a suitable coating machine, and thus a cellulose acylate film having a laminated structure is molded.

The compound described above is contained in one or more of the layers or in all of the layers, and thus it is possible to obtain a cellulose acylate film having high surface hardness.

(Stretching Treatment)

It is preferable that the manufacturing method of the cellulose acylate film includes a step of stretching after forming. It is preferable that a stretching direction of the cellulose acylate film is either a cellulose acylate film transport direction (an MD direction) or a direction orthogonal to the transport direction (a TD direction), and it is particularly preferable that the cellulose acylate film is stretched in the direction orthogonal to the cellulose acylate film transport direction (the TD direction) from a viewpoint of a machining process of a polarizing plate using the cellulose acylate film, which follows after the stretching.

A method of stretching the film in the TD direction, for example, is disclosed in each publication of JP1987-115035A (JP-S62-115035A), JP1992-152125A (JP-H04-152125A), JP1992-284211A (JP-H04-284211A), JP1992-298310A (JP-H04-298310A), JP1999-48271A (JP-H11-48271A), and the like. In a case where the film is stretched in the MD direction, for example, when the speed of a transportation roller of the cellulose acylate film is adjusted, and thus the winding speed of the cellulose acylate film is faster than the peeling speed of the cellulose acylate film, the cellulose acylate film is stretched. In a case where the film is stretched in the TD direction, the cellulose acylate film is able to be stretched by transporting the cellulose acylate film while holding the width of the cellulose acylate film with a tenter, and by gradually widening the width of the tenter. It is also possible to stretch the cellulose acylate film by using a stretching machine (preferably monoaxial stretching using a long stretching machine) after drying the cellulose acylate film.

When the cellulose acylate film is used as a protective film of a polarizer, light leakage is suppressed when a polarizing plate is obliquely viewed, and thus it is necessary that a transmission axis of the polarizer and an in-plane slow axis of the cellulose acylate film are arranged to be parallel to each other. In general, a transmission axis of a roll film-like polarizer which is continuously manufactured is parallel to a width direction of the roll film, and thus in order to continuously bond the protective film which is formed of the roll film-like polarizer described above and a roll film-like cellulose acylate film, it is necessary that an in-plane slow axis of the roll film-like protective film is parallel to a width direction of the cellulose acylate film. Accordingly, it is more preferable that the stretching is more frequently performed in the TD direction. In addition, the stretching treatment may be performed during a film forming step, or a raw fabric which is formed and is wound may be subjected to the stretching treatment.

The stretching in the TD direction is preferably stretching of 5% to 100%, is more preferably stretching of 5% to 80%, and is particularly preferably stretching of 5% to 40%. Furthermore, non-stretching indicates that the stretching is 0%. The stretching treatment may be performed during the film forming step, or a raw fabric which is formed and is wound may be subjected to the stretching treatment. In the former case, the stretching may be performed in a state of including a residual solvent, and the stretching is able to be preferably performed when Amount of Residual Solvent=(Residual Volatile Component Mass/Film Mass after Heating Treatment)×100% is 0.05% to 50%. It is particularly preferable that stretching of 5% to 80% is performed in a state where the amount of residual solvent is 0.05% to 5%.

The cellulose acylate film containing the compound described above is subjected to the stretching treatment, and thus it is possible to further increase the surface hardness of the film.

<Physical Properties of Cellulose Acylate Film>

Surface Hardness:

The cellulose acylate film of the present invention contains the compound described above, and thus is able to have high surface hardness. The surface hardness of the cellulose acylate film is able to be adjusted by the type or the content of the compound denoted by Formula A. Knoop hardness is able to be used as an index of the surface hardness of the cellulose acylate film. The Knoop hardness is able to be measured by a method described below in examples.

Modulus of Elasticity:

The cellulose acylate film exhibits practically sufficient modulus of elasticity. The range of the modulus of elasticity is not particularly limited, but is preferably 1.0 GPa to 6.0 GPa, and is more preferably 2.0 GPa to 5.0 GPa from a viewpoint of manufacturing suitability and handling properties. The compound described above is added into the cellulose acylate film, and thus the cellulose acylate film is hydrophobized and the modulus of elasticity is improved, and these properties are advantages of the present invention.

Photoelastic Coefficient:

The absolute value of a photoelastic coefficient of the cellulose acylate film is preferably less than or equal to 8.0×10⁻¹² m²/N, is more preferably less than or equal to 6×10⁻¹² m²/N, and is even more preferably less than or equal to 5×10⁻¹² m²/N. The photoelastic coefficient of the cellulose acylate film decreases, and thus when the cellulose acylate film of the present invention is incorporated in a liquid-crystal display device as a polarizing plate protective film, it is possible to suppress the occurrence of unevenness under high temperature and high humidity. The photoelastic coefficient, unless otherwise specifically stated, is calculated by being measured according to the following methods.

The lower limit value of modulus of photoelasticity is not particularly limited, and it is practical that the lower limit value of modulus of photoelasticity is greater than or equal to 0.1×10⁻¹² m²/N.

The cellulose acylate film is cut to have a size of 3.5 cm×12 cm, and the photoelastic coefficient is measured by being calculated from a slope of a straight line of a change in Re corresponding to a stress by measuring Re with an ellipsometer (M150, manufactured by Jasco Corporation) at each load of no load, 250 g, 500 g, 1000 g, and 1500 g.

Moisture Content:

The moisture content of the cellulose acylate film is able to be evaluated by measuring an equilibrium moisture content at a constant temperature and humidity. The equilibrium moisture content is calculated by measuring the moisture amount of a sample which reaches equilibrium after being placed for 24 hours at the temperature and humidity described above using a Karl Fischer method, and by dividing a moisture amount (g) by a sample mass (g).

The moisture content of the cellulose acylate film at a temperature of 25° C. and relative humidity of 80% is preferably less than or equal to 5 mass %, is more preferably less than or equal to 4 mass %, and is even more preferably less than 3 mass %. The moisture content of the cellulose acylate film decreases, and thus when the cellulose acylate film of the present invention is incorporated in the liquid-crystal display device as the polarizing plate protective film, it is possible to suppress the occurrence of display unevenness of the liquid-crystal display device under high temperature and high humidity. The lower limit value of the moisture content is not particularly limited, and it is practical that the lower limit value of the moisture content is greater than or equal to 0.1 mass %.

Moisture Permeability:

The moisture permeability of the cellulose acylate film is able to be evaluated by measuring the mass of water vapor per 24 hours passing through the sample in an atmosphere of a temperature of 40° C. and relative humidity of 90% on the basis of a moisture permeability test (a cup method) of JIS Z0208, and by converting the mass of the water vapor per 24 hours into the mass of the water vapor passing through for 24 hours per a sample area 1 m².

The moisture permeability of the cellulose acylate film is preferably 500 g/m²·day to 2000 g/m²·day, is more preferably 900 g/m²·day to 1300 g/m²·day, and is particularly preferably 1000 g/m²·day to 1200 g/m²·day.

Haze:

The haze of the cellulose acylate film is preferably less than or equal to 1%, is more preferably less than or equal to 0.7%, and is particularly preferably less than or equal to 0.5%. By setting the haze to be less than or equal to the upper limit value described above, advantages such as a further increase in transparency of the cellulose acylate film and ease of use as an optical film are obtained. The haze, unless otherwise specifically stated, is calculated by being measured according to the following methods. The lower limit value of the haze is not particularly limited, and it is practical that the lower limit value of the haze is greater than or equal to 0.001%.

The haze of a cellulose acylate film of 40 mm×80 mm is measured under an environment of a temperature of 25° C. and relative humidity of 60% by using a hazemeter (HGM-2DP, manufactured by Suga test Instruments Co., Ltd.) according to JIS K7136.

Film Thickness:

The average film thickness of the cellulose acylate film is able to be suitably set according to application, and for example, is 10 m to 100 μm. The average film thickness of the cellulose acylate film is preferably greater than or equal to 15 μm, and is more preferably greater than or equal to 20 μm, from a viewpoint of improving handling properties at the time of preparing a web-like film. In addition, the average film thickness of the cellulose acylate film is preferably less than or equal to 100 μm, is more preferably less than or equal to 80 μm, and is even more preferably less than or equal to 70 μm, from a viewpoint of easily dealing with a humidity change and of easily maintaining optical properties.

In addition, when the cellulose acylate film has a laminated structure of three or more layers, the film thickness of the core layer is preferably 3 μm to 70 μm, and is more preferably 5 μm to 60 μm, and the film thickness of a skin layer A and a skin layer B is preferably 0.5 μm to 20 μm, is particularly preferably 0.5 μm to 10 μm, and is most preferably 0.5 μm to 3 μm. The core layer indicates a layer positioned in the center portion in the three-layer structure, and the skin layer indicates a layer positioned on an outer side in the three-layer structure.

Width:

The width of the cellulose acylate film is preferably 700 mm to 3000 mm, is more preferably 1000 mm to 2800 mm, and is particularly preferably 1300 mm to 2500 mm.

(Saponification Treatment)

The cellulose acylate film is able to be used as the polarizing plate protective film by applying adhesiveness with respect to the material of the polarizer such as polyvinyl alcohol through an alkali saponification treatment.

A method disclosed in paragraph 0211 and paragraph 0212 of JP2007-86748A is able to be used as a saponification method.

For example, it is preferable that the alkali saponification treatment with respect to the cellulose acylate film is performed in a cycle where the film surface is dipped in an alkali solution, and then is neutralized with an acidic solution, and is washed with water and dried. Examples of the alkali solution described above include a potassium hydroxide solution and sodium hydroxide solution, and the concentration of hydroxide ions is preferably in a range of 0.1 mol/L to 5.0 mol/L, and is more preferably in a range of 0.5 mol/L to 4.0 mol/L. An alkali solution temperature is preferably in a range of room temperature to 90° C., and is more preferably in a range of 40° C. to 70° C.

Easy adhesion processing as disclosed in JP1994-94915A (JP-H06-94915A) and JP1994-118232A (JP-H06-118232A) may be performed instead of the alkali saponification treatment.

[Polarizing Plate]

A polarizing plate of the present invention includes the cellulose acylate film described above, and a polarizer.

In one aspect, the cellulose acylate film of the present invention is included in a polarizing plate as a protective film. The polarizing plate according to this aspect includes a polarizer, and two polarizing plate protective films (transparent films) protecting both surfaces of the polarizer, and includes the cellulose acylate film of the present invention as at least one polarizing plate protective film.

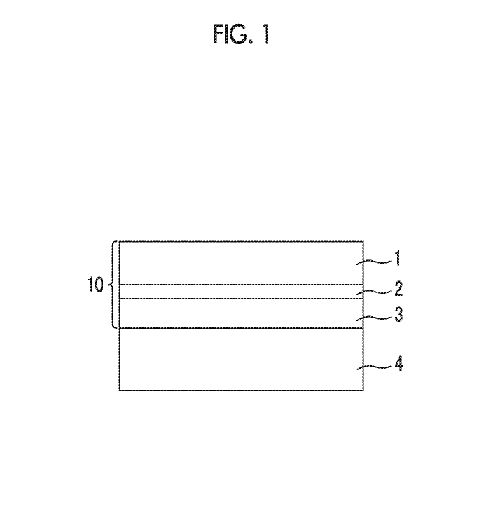

The cellulose acylate film of the present invention, in particular, is preferably used as a protective film on a visible side of an upper side polarizing plate 10. FIG. 1 is an example illustrating one aspect of a positional relationship between the polarizing plate of the present invention and a liquid-crystal display device, in which “1” indicates the cellulose acylate film of the present invention, “2” indicates the polarizer, “3” indicates a retardation film, and “4” indicates a liquid-crystal cell, respectively. In addition, an upper side of FIG. 1 is a visible side.

As illustrated in FIG. 1, the retardation film 3 is preferably used as a polarizing plate protective film on a side on which the cellulose acylate film of the present invention is not used, and a retardation film in which various additives are blended with the cellulose acylate film or a desired phase difference is expressed by stretching, or a retardation film including an optical anisotropic layer formed of a liquid-crystal composition on the surface of the support is exemplified as this retardation film. Specifically, the retardation film is able to refer to a retardation film disclosed in JP2008-262161 A, and the contents are incorporated herein.

In addition, for example, a polarizer in which a polyvinyl alcohol film is dipped in an iodine solution and is stretched is able to be used as the polarizer. When the polarizer in which the polyvinyl alcohol film is dipped in the iodine solution and is stretched is used, the surface treated surface of the cellulose acylate film of the present invention is able to be directly bonded to at least one surface of the polarizer by using an adhesive agent. An aqueous solution of polyvinyl alcohol or polyvinyl acetal (for example, polyvinyl butyral), latex of a vinyl-based polymer (for example, polybutyl acrylate), and a curable adhesive agent composition containing an epoxy compound which is cured by irradiation of an active energy ray or heat are able to be used as the adhesive agent described above. It is particularly preferable that the adhesive agent is an aqueous solution of completely saponified polyvinyl alcohol.

It is preferable that the polarizing plate protective film of present invention is bonded to the polarizer such that a transmission axis of the polarizer and a slow axis of the polarizing plate protective film described above are orthogonal to each other, parallel to each other, or at an angle of 45°. The slow axis is able to be measured by various known methods, and for example, is able to be measured by using a birefringence meter (KOBRA DH, manufactured by Oji Scientific Instruments). Here, in the present invention, the descriptions about an angle include a range of error which is allowable in the art to which the present invention belongs. For example, the expressions “orthogonal” and “parallel” indicates that the angle is in a range of less than ±100 from an exact angle relevant to parallel and orthogonal, and an error from the exact angle is preferably less than or equal to 5°, and is more preferably less than or equal to 3°.

Setting the transmission axis of the polarizer layer and the slow axis of the polarizing plate protective film to be parallel to each other indicates that the direction of the main refractive index nx of the polarizing plate protective film and the direction of the transmission axis of the polarizing plate intersect with each other at an angle of ±10°. The angle is preferably within 5°, is more preferably within 3°, is even more preferably within 1°, and is most preferably within 0.5°.

In addition, setting the transmission axis of the polarizer and the slow axis of the polarizing plate protective film to be orthogonal to each other indicates that the direction of the main refractive index nx of the polarizing plate protective film and the direction of the transmission axis of the polarizer intersect with each other at an angle of 90°±10°. The angle is preferably 90°±5°, is more preferably 90°±3°, is even more preferably 90°±1°, and is most preferably 90°±0.5°. By setting the error to be within 10, a decrease in performance of a polarization degree under crossed-Nicols rarely occurs, and light leakage rarely occurs.

<Functionalization of Polarizing Plate>

It is preferable that the polarizing plate of the present invention is used as a functionalized polarizing plate which is combined with an antireflection film and a brightness enhancement film for improving visibility of a display, or an optical film including a functional layer such as a hard coat layer, a forward scattering layer, and an anti-glare layer, within a range not departing from the gist of the present invention. The details thereof are able to refer to the description in paragraphs 0229 to 0242 and paragraphs 0249 to 0250 of JP2012-082235A and in paragraphs 0086 to 0103 of JP2012-215812A, and the contents are incorporated herein.

<Hard Coat Layer>

A hard coat layer which is preferably disposed on the cellulose acylate film as necessary is a layer for applying hardness or scratch resistance to the polarizing plate of the present invention. For example, a coating composition is applied onto the cellulose acylate film and is cured, and thus the hard coat layer is able to be formed on the cellulose acylate film. A filler or an additive is added to the hard coat layer, and thus mechanical performance, electrical performance, optical performance, physical performance, or chemical performance such as water repellency and oil repellency is able to be applied to the hard coat layer itself. The thickness of the hard coat layer is preferably in a range of 0.1 μm to 6 μm, and is more preferably in a range of 3 μm to 6 μm. By including a thin hard coat layer in such a range, a polarizing plate including the hard coat layer is obtained in which physical properties such as suppression of brittleness or curling are enhanced, and a reduction in weight and a reduction in manufacturing costs are realized.

It is preferable that the hard coat layer is formed by curing a curable composition. It is preferable that the curable composition is prepared as a liquid-like coating composition. An example of such a coating composition contains a monomer or an oligomer for a matrix forming binder, polymers, and an organic solvent. This coating composition is cured after being coated, and thus the hard coat layer is able to be formed. In the curing, a cross-linking reaction or a polymerization reaction is able to be used. The details thereof are able to refer to the description in paragraphs 0088 to 0101 of JP2012-215812A, and the contents are incorporated herein.

A curable composition which is particularly preferable for forming the hard coat layer is a composition containing a (meth)acrylate-based compound as used in examples described below.

It is preferable that the curable composition is prepared as a coating liquid. The coating liquid is able to be prepared by dissolving and/or dispersing the component described above in an organic solvent.

(Properties of Hard Coat Layer)

It is preferable that the hard coat layer formed on the cellulose acylate film has high adhesiveness with respect to the cellulose acylate film. In the hard coat layer formed of the preferred curable composition described above on the cellulose acylate film containing the compound described above, the curable composition is able to exhibit high adhesiveness with respect to the cellulose acylate film along with the compound described above. The polarizing plate of the present invention includes such a cellulose acylate film and a hard coat layer, and thus it is possible to maintain adhesiveness between the cellulose acylate film and the hard coat layer even when light irradiation or the like is performed, and it is possible to exhibit excellent optical durability.

It is preferable that the hard coat layer has excellent scratch resistance. Specifically, when a pencil hardness test which is an index of scratch resistance is performed, it is preferable that hardness of greater than or equal to 3H is attained.

<Liquid-Crystal Display Device>

A liquid-crystal display device of the present invention includes at least one polarizing plate of the present invention. The details of the liquid-crystal display device are able to refer to the description in paragraphs 0251 to 0260 of JP2012-082235A, and the contents are incorporated herein.

### EXAMPLES

Hereinafter, the present invention will be more specifically described with reference to examples. Materials, used amounts, ratios, treatment contents, treatment sequences, and the like of the following examples are able to be suitably changed unless the changes cause deviance from the gist of the present invention. Accordingly, the range of the present invention is not limited to the following specific examples.

Identification of all synthesized compounds was performed by using one or more of ¹H-NMR (300 MHz), Matrix-Assisted Laser Desorption/Ionization Time of Flight Mass Spectrometry (MALDI-TOF-MS), and Liquid Chromatography/Mass Spectrometry (LC/MS). In addition, a melting point was measured by using a trace melting point measure device (MP-500D, manufactured by Yanaco New Science Inc.).

The following compound numbers are the numbers of the exemplary compounds described above.

### Synthesis Example 1

### Synthesis of Compound 1-9

107 g (1.5 mol) of cyano ethanol, 200 mg of n-dibutyl tin diacetate, and 750 mL of ethyl acetate were put into a three-neck flask of 2 L which was attached with a mechanical stirrer, a thermometer, a cooling pipe, and a dripping funnel, and 100 ml. of an ethyl acetate solution of 167 g (0.75 mol) of isophorone diisocyanate was dripped into the three-neck flask for 30 minutes under ice cooling. After that, a reaction was performed at 50° C. for 4 hours. A reaction mixture was concentrated, and was purified by silica gel column chromatography (a solvent of ethyl acetate/n-hexane) to be a white solid, and thus 189 g of a compound 1-9 was obtained (a yield of 70%).

MALDI-TOF-MS: M+Na; 387

### Synthesis Example 2

### Synthesis of Mixture of Compound 2-2-A and Compound 2-2-B

44.4 g (0.20 mol) of isophorone diisocyanate and 150 mL of THF were put into a three-neck flask which was attached with a mechanical stirrer, a thermometer, a cooling pipe, and a dripping funnel, and 50 mL of a THF solution of 24.6 g (0.25 mol) of imino dipropionitrile was dripped into the flask at room temperature of lower than or equal to 10° C. After that, the mixture was stirred at 60° C. for 4 hours, and then 10 mg of n-dibutyl tin diacetate and 27.6 g (0.20 mol) of phenoxy ethanol were dripped into the mixture at room temperature, and a reaction was further performed at 60° C. for 4 hours. A solvent was concentrated after the reaction ended, and the mixture was purified by silica gel column chromatography (a solvent of ethyl acetate/n-hexane/methanol), and thus 34 g of a mixture of a compound 2-2-A and a compound 2-2-B was obtained as a glass-like solid (a yield of 35%).

MALDI-TOF-MS M+Na: 507

### Synthesis Example 3

A compound 1-16, a compound 1-14, a compound 1-3, and a compound 1-6 were synthesized by the same method as that in Synthesis Example 1 except that the cyano ethanol in the synthesis of the compound 1-9 was changed to N-(2-hydroxy ethyl) succinimide, N-(2-hydroxy ethyl) hexahydroxy phthalimide, imino dipropionitrile, and imino diacetonitrile.

### Synthesis Example 4

A compound 1-7 was synthesized by the same method as that in Synthesis Example 1 except that the isophorone diisocyanate in the synthesis of the compound 1-9 was changed to xylylene diisocyanate.

### Synthesis Example 5

A mixture of a compound 2-3-A and a compound 2-3-B, and a compound 3-7 were synthesized by the same method as that in Synthesis Example 2 except that the imino dipropionitrile in the synthesis of the mixture of the compound 2-2-A and the compound 2-2-B is changed to imino diacetonitrile and methyl glycine.

### Synthesis Example 6

A compound 1-11, a mixture of a compound 2-5-A and a compound 2-5-B, a mixture of a compound 2-6-A and a compound 2-6-B, a compound 3-1, a compound 3-9, a compound 3-13, a compound 3-20, a compound 3-21, and a compound 3-22 were synthesized by the same method as that in any one of Synthesis Examples 1 to 5 except that diisocyanate, alcohol, and amine which were raw materials were suitably changed.

### Synthesis Example 7

### Synthesis of Compound 4-1-A

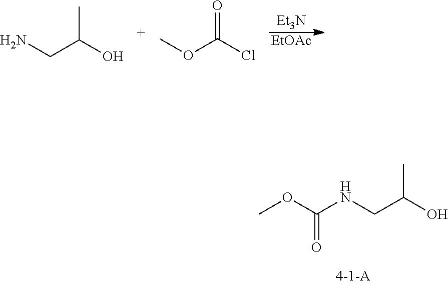

(Et: Ethyl Group)

79.5 g (1.06 mol) of 1-amino-2-propanol, 80.3 g (0.79 mol) of triethyl amine, and 700 ml of ethyl acetate were put into a three-neck flask which was attached with a mechanical stirrer, a thermometer, and a dripping funnel, and were cooled to 0° C., and a mixed solution of 50 g (0.53 mol) of methyl chloroformate and 50 ml of ethyl acetate was dripped into the flask. The mixture was stirred for 30 minutes, and then 400 ml of water and 75 ml of a concentrated hydrochloric acid were added to the mixture, liquid separation was performed, and then 200 ml of water was added to the mixture, and the liquid separation was performed again. An organic layer was subjected to a dehydration treatment with sodium sulfate, filtration, and solvent concentration, and thus 52.9 g of a compound 4-1-A was obtained (a yield of 75%).

### Synthesis of Compound 4-1

21.3 g (0.11 mol) of metaxylylene diisocyanate, 0.36 g of dibutyl tin dilaurate, and 115 ml of ethyl acetate were put into a three-neck flask which was attached with a mechanical stirrer, a thermometer, a cooling pipe, and a dripping funnel, and were cooled to 0° C., and 18.1 g (0.14 mol) of the compound 4-1-A was dripped into the flask. The mixture was stirred at room temperature for 3 hours, and then 2.9 g of methanol was added to the mixture, and was stirred for 4 hours.

An educed white solid was filtered after the reaction ended, and was purified by silica gel column chromatography (a solvent of ethyl acetate/n-hexane/methanol), and thus 26.3 g of a compound 4-1 was obtained as the white solid (a yield of 66%).

¹H-NMR (CDCl₃) δ1.2 (d, J=7.5 Hz, 3H), 3.5-3.2 (br, 2H), 3.6 (s, 3H), 3.7 (s, 3H), 4.4 (m, 4H), 5.1-4.8 (br, 4H), 7.2 (m, 3H), 7.3 (m, 1H)

LC/MS(ESI(+)): 376.4[M+Na]

### Synthesis of Compound 4-2

30.1 g (0.23 mol) of the compound 4-1-A, 0.36 g of dibutyl tin dilaurate, and 115 ml of ethyl acetate were put into a three-neck flask which was attached with a mechanical stirrer, a thermometer, a cooling pipe, and a dripping funnel, and were cooled to 0° C., and 21.3 g (0.11 mol) of metaxylylene diisocyanate was dripped into the flask. The mixture was stirred at room temperature for 4 hours, and then 2.0 g of methanol was added to the mixture, and was stirred for 1 hour.

An educed white solid was filtered after the reaction ended, and was purified by silica gel column chromatography (a solvent of ethyl acetate/n-hexane/methanol), and thus 46.5 g of a compound 4-2 was obtained as the white solid (a yield of 93%).

¹H-NMR (CDCl₃) δ1.2 (d, J=7.5 Hz, 6H), 3.5-3.2 (br, 4H), 3.6 (s, 6H), 4.3 (m, 4H), 5.1-4.9 (br, 4H), 7.2 (m, 3H), 7.3 (m, 1H)

LC/MS(ESI(+)): 355.3 [M+H]

### Synthesis Example 8

### Synthesis of Compound 4-3

A compound 4-3 was synthesized by the same method as that in the synthesis of the compound 4-1 in Synthesis Example 7 except that the 1-amino-2-propanol in the synthesis of the compound 4-1-A was changed to 1-aminoethanol.

### Synthesis of Compound 4-4

A compound 4-4 was synthesized by the same method as that in the synthesis of the compound 4-2 in Synthesis Example 7 except that the 1-amino-2-propanol in the synthesis of the compound 4-1-A was changed to 1-aminoethanol.

### Synthesis Example 9

### Synthesis of Compound 4-5-A

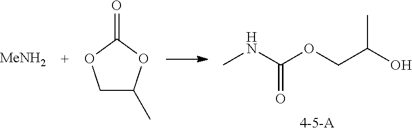

(Me: Methyl Group)

51.0 g (0.50 mol) of propylene carbonate was put into a three-neck flask which was attached with a mechanical stirrer, a thermometer, and a dripping funnel, and 61 ml (0.60 mol) of methyl amine [40% of a methanol solution] was dripped into the flask while being stirred at room temperature. The mixture was stirred at room temperature for 3 hours, and then vacuum concentration for removing excessive methyl amine was performed, and thus 65.9 g of a compound 4-5-A was obtained as a colorless liquid (a yield of 99%).

### Synthesis of Compound 4-5

A compound 4-5 was synthesized by the same method as that in Synthesis Example 7 except that the compound 4-1-A which was the raw material in the synthesis of the compound 4-1 was changed to the compound 4-5-A.

### Synthesis of Compound 4-6

A compound 4-6 was synthesized by the same method as that in Synthesis Example 7 except that the compound 4-1-A which was the raw material in the synthesis of the compound 4-2 was changed to the compound 4-5-A (a yield of 64%).

¹H-NMR (DMSO-d6) δ1.2 (m, 6H), 2.6 (s, 6H), 4.0 (m, 4H), 4.1 (d, J=6.3 Hz, 4H), 4.8 (m, 2H), 7.0 (s, 1H), 7.1 (m, 4H), 7.2 (m, 1H), 7.8-7.7 (br, 2H)

LC/MS(ESI(+)): 477.4[M+Na]

### Synthesis Example 10

### Synthesis of Compound 4-7

A compound 4-7 was synthesized by the same method as that in the synthesis of the compound 4-5 in Synthesis Example 9 except that the methyl amine in the synthesis of the compound 4-5-A was changed to ethyl amine.

### Synthesis of Compound 4-8

A compound 4-8 was synthesized by the same method as that in the synthesis of the compound 4-6 in Synthesis Example 9 except that the methyl amine in the synthesis of the compound 4-5-A was changed to ethyl amine.

### Synthesis of Compound 4-9

A compound 4-9 was synthesized by the same method as that in the synthesis of the compound 4-5 in Synthesis Example 9 except that the methyl amine in the synthesis of the compound 4-5-A was changed to isopropyl amine.

### Compound 4-10

A compound 4-10 was synthesized by the same method as that in the synthesis of the compound 4-6 in Synthesis Example 9 except that the methyl amine in the synthesis of the compound 4-5-A was changed to isopropyl amine.

### Synthesis of Compound 4-12-B

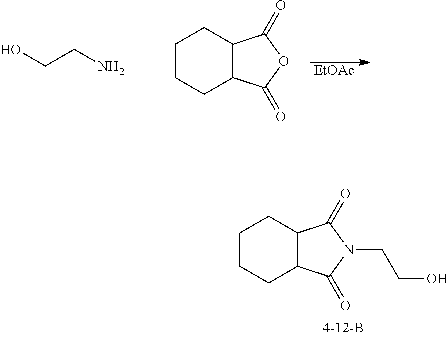

50.0 g (0.32 mol) of cis-1,2-cyclohexane dicarboxylic anhydride and 330 mL of toluene were put into a three-neck flask which was attached with a mechanical stirrer, a thermometer, and a dripping funnel, and 19.8 g (0.32 mol) of 2-aminoethanol was dripped into the flask. The mixture was stirred at 130° C. for 3 hours, and then was cooled to room temperature. 200 mL of ethyl acetate and 200 mL of a hydrochloric acid of 1 N concentration were added to the mixture, liquid separation was performed, and then 1 L of water and 0.5 L of a saturated saline solution were further added to the mixture, and the liquid separation was performed again. An organic layer was subjected to a dehydration treatment with sodium sulfate, filtration, and solvent concentration, and thus 62.9 g of a compound 4-12-B was obtained (a yield of 98%).

### Synthesis Example 11

### Synthesis of Compound 4-11

21.3 g (0.11 mol) of metaxylylene diisocyanate, 0.36 g of dibutyl tin dilaurate, and 115 ml of ethyl acetate were put into a three-neck flask which was attached with a mechanical stirrer, a thermometer, a cooling pipe, and a dripping funnel, and were cooled to 0° C., and 18.6 g (0.14 mol) of the compound 4-5-A was dripped into the flask. The mixture was stirred at room temperature for 3 hours, and 7.8 g (0.11 mol) of cyano ethanol was added to the mixture, and was stirred for 4 hours.

An educed white solid was filtered after the reaction ended, and was purified by silica gel column chromatography (a solvent of ethyl acetate/n-hexane/methanol), and thus 29.3 g of a compound 4-11 was obtained as the white solid (a yield of 68%).

¹H-NMR (DMSO-d6) 61.2 (m, 3H), 2.6 (s, 3H), 2.8 (m, 2H), 4.2-4.0 (m, 8H), 4.8 (m, 1H), 7.1-7.0 (m, 4H), 7.3-7.2 (m, 2H), 7.8-7.7 (br, 1H)

### Synthesis of Compound 4-12

A compound 4-12 was synthesized by the same method as that in the synthesis of the compound 4-11 except that the cyano ethanol in the synthesis of the compound 4-11 was changed to the compound 4-12-B.

### Synthesis Example 12

### Synthesis of Compound 5-1

49.8 g (0.22 mol) of isophorone diisocyanate, 0.71 g of dibutyl tin dilaurate, and 225 ml of ethyl acetate were put into a three-neck flask which was attached with a mechanical stirrer, a thermometer, a cooling pipe, and a dripping funnel, and were cooled to 0° C., and 35.8 g (0.27 mol) of the compound 4-1-A was dripped into the flask. The mixture was stirred at 45° C. for 3 hours, and then 5.7 g of methanol was added to the mixture, and was stirred for 4 hours. A reaction mixture was concentrated after the reaction ended, and was purified by silica gel column chromatography (a solvent of ethyl acetate/n-hexane/methanol), and thus 26.9 g of a compound 5-1 was obtained as a glass-like solid (a yield of 31%).

¹H-NMR (DMSO-d6) δ1.1-0.8 (br, 16H), 1.5-1.3 (br, 2H), 2.7 (m, 2H), 3.1 (m, 2H), 3.5 (br, 7H), 4.6 (Hex, J=6.3 Hz, 1H), 7.2-6.7 (br, 3H)

LC/MS(ESI(+)): 410.4[M+Na]

### Synthesis of Compound 5-2

58.2 g (0.44 mol) of the compound 4-1-A, 0.36 g of dibutyl tin dilaurate, and 115 ml of ethyl acetate were put into a three-neck flask which was attached with a mechanical stirrer, a thermometer, a cooling pipe, and a dripping funnel, and were cooled to 0° C., and 49.8 g (0.22 mol) of isophorone diisocyanate was dripped into the flask. The mixture was stirred at 60° C. for 6 hours, and then 2.0 g of methanol was added to the mixture, and was stirred for 1 hour.

A reaction mixture was concentrated after the reaction ended, and was purified by silica gel column chromatography (a solvent of ethyl acetate/n-hexane/methanol), and thus 97.5 g of a compound 5-2 was obtained as a glass-like solid (a yield of 89%).

¹H-NMR (DMSO-d6) δ1.1-0.8 (br, 19H), 1.5-1.3 (br, 2H), 2.7 (m, 2H), 3.1 (m, 4H), 3.5 (br, 7H), 4.6 (Hex, J=6.3 Hz, 2H), 7.2-6.7 (br, 4H)

LC/MS(ESI(+)): 489.4[M+H]

### Synthesis Example 13

A compound 5-3 and a compound 5-4 were synthesized by the same method as that in Synthesis Example 12 except that the 1-amino-2-propanol in the synthesis of the compound 5-1 and the compound 5-2 was changed to 1-aminoethanol.

### Synthesis Example 14

### Synthesis of Compound 5-5

A compound 5-5 was synthesized by the same method as that in Synthesis Example 12 except that the compound 4-1-A in the synthesis of the compound 5-1 was changed to the compound 4-5-A.

### Synthesis of Compound 5-6

A compound 5-6 was synthesized by the same method as that in Synthesis Example 12 except that the compound 4-1-A in the synthesis of the compound 5-2 was changed to the compound 4-5-A.

¹H-NMR (DMSO-d6) δ1.2-0.8 (br, 19H), 1.5-1.4 (br, 2H), 2.5 (m, 6H), 2.8-2.6 (br, 2H), 3.7-3.5 (br, 1H), 4.0-3.9 (br, 4H), 4.9-4.7 (br, 2H), 7.3-6.8 (br, 4H)

LC/MS(ESI(+)): 511.4[M+Na]

### Synthesis Example 15

A compound 5-7, a compound 5-8, a compound 5-9, and a compound 5-10 were synthesized by the same method as that in Synthesis Example 14 except that the methyl amine in the synthesis of the compound 4-5-A was changed to ethyl amine and isopropyl amine.

### Synthesis Example 16

### Synthesis of Compound 5-11

24.5 g (0.11 mol) of isophorone diisocyanate, 0.36 g of dibutyl tin dilaurate, and 115 ml of ethyl acetate were put into a three-neck flask which was attached with a mechanical stirrer, a thermometer, a cooling pipe, and a dripping funnel, and were cooled to 0° C., and 18.6 g (0.14 mol) of the compound 4-5-A was dripped into the flask. The mixture was stirred at room temperature for 3 hours, and then 7.8 g (0.11 mol) of cyano ethanol was added, and was stirred for 4 hours.

The mixture was purified by silica gel column chromatography (a solvent of ethyl acetate/n-hexane/methanol) after the reaction ended, and thus 30.5 g of a compound 5-11 was obtained (a yield of 65%).

¹H-NMR (DMSO-d6) δ1.2-0.8 (br, 161H), 1.5-1.4 (br, 2H), 2.5 (m, 3H), 2.8-2.6 (m, 4H), 3.7-3.6 (br, H), 4.1-3.9 (m, 4H), 4.9-4.7 (br, 1H), 7.3-6.8 (br, 3H)

### Synthesis of Compound 5-12

A compound 5-12 was synthesized by the same method as that in the synthesis of the compound 5-11 except that the cyano ethanol in the synthesis of the compound 5-11 was changed to the compound 4-12-B.

### Synthesis Example 17

### Synthesis of Compound 6-1

88.9 g (0.40 mol) of isophorone diisocyanate, 1.3 g of dibutyl tin dilaurate, and 500 ml of ethyl acetate were put into a three-neck flask which was attached with a mechanical stirrer, a thermometer, a cooling pipe, and a dripping funnel, and were cooled to 0° C., and a mixed solution of 15.4 g (0.48 mol) of methanol and 30 mL of ethyl acetate was dripped into the flask. The mixture was stirred at 0° C. for 1.5 hours, and then was heated to 60° C., a mixed solution of 6.1 g (0.08 mol) of 1,2-propane diol and 30 mL of ethyl acetate was added to the mixture, and was stirred for 4 hours. The mixture was purified by silica gel column chromatography (a solvent of ethyl acetate/n-hexane) after the reaction ended, and thus 12.5 g of a compound 6-1 was obtained as a glass-like solid (a yield of 10%).

¹H-NMR (DMSO-d6) δ1.2-0.8 (br, 33H), 1.7-1.3 (br, 5H), 2.7 (m, 3H), 3.7-3.4 (br, 8H), 4.0 (m, 1H), 4.8 (s, 1H), 7.2-6.8 (br, 4H)

### Synthesis Example 18

A compound 6-2 was synthesized by the same method as that in Synthesis Example 17 except that the isophorone diisocyanate in the synthesis of the compound 6-1 was changed to metaxylylene diisocyanate (a yield of 14%).

¹H-NMR (DMSO-d6) δ1.2-1.0 (br, 3H), 3.5 (s, 6H), 4.2-4.0 (br, 10H), 4.9 (m, 1H), 7.3-7.1 (br, 8H), 7.8-7.6 (m, 4H)

### Synthesis Example 19

A compound 6-3 was synthesized by the same method as that in Synthesis Example 17 except that the isophorone diisocyanate and the methanol in the synthesis of the compound 6-1 were changed to metaxylylene diisocyanate and 2-cyano ethanol (a yield of 5%).

¹H-NMR (DMSO-d6) δ1.3-1.0 (br, 3H), 2.8 (t, 4H), 4.3-4.0 (br, 19H), 4.9 (m, 1H), 7.3-7.1 (br, 8H), 8.0-7.6 (br, 4H)

### Synthesis Example 20

### Synthesis of Compound 6-4-A

114.1 g (1.50 mol) of 1,2-propane diol, 0.9 mL (1.5 mmol) of dibutyl tin dilaurate, and 500 ml of ethyl acetate were put into a three-neck flask which was attached with a mechanical stirrer, a thermometer, a cooling pipe, and a dripping funnel, and were cooled to 0° C., and a mixed solution of 56.5 g (0.30 mol) of metaxylylene diisocyanate and 100 mL of ethyl acetate was dripped into the flask. The mixture was stirred at 0° C. for 1.5 hours, and was placed in a room temperature environment (25° C.), and thus the temperature of the mixture returned to room temperature.

A reaction liquid was washed with 200 mL of water, and then was washed with 200 mL of water and 100 mL of a saturated saline solution two times. The reaction liquid was dried with magnesium sulfate, and was concentrated, and thus 83.5 g of a compound 6-4-A was obtained as a colorless liquid (a yield of 82%).

### Synthesis of Compound 6-4

56.5 g (0.30 mol) of metaxylylene diisocyanate, 0.9 mL (1.5 mmol) of dibutyl tin dilaurate, and 300 ml of ethyl acetate were put into a three-neck flask which was attached with a mechanical stirrer, a thermometer, a cooling pipe, and a dripping funnel, and were cooled to 0° C., and a mixed solution of 11.5 g (0.36 mol) of methanol and 30 mL of ethyl acetate was dripped into the flask. The mixture was stirred at 0° C. for 1.5 hours, and then was heated to 60° C., a mixed solution of 33.6 g (0.06 mol) of the compound 6-4-A and 130 mL of ethyl acetate was added to the mixture in two times, and was stirred for 4 hours. The mixture was purified by silica gel column chromatography (a solvent of ethyl acetate/n-hexane) after the reaction ended, and thus 12.1 g of a compound 6-4 was obtained as a white solid (a yield of 5%).

¹H-NMR (DMSO-d6) 81.3-1.0 (br, 6H), 3.6 (s, 6H), 4.3-4.0 (br, 17H), 4.9 (m, 2H), 7.3-7.1 (br, 12H), 8.0-7.6 (br, 6H)

### Synthesis Example 21

### Synthesis of Compound 6-5

66.7 g (0.30 mol) of isophorone diisocyanate, 0.84 g of Neostann U-600 (manufactured by NITTO KASEI CO., LTD.), and 170 ml of ethyl acetate were put into a three-neck flask which was attached with a mechanical stirrer, a thermometer, a cooling pipe, and a dripping funnel, and were cooled to 0° C., and a mixed solution of 11.4 g (0.15 mol) of 1,2-propane diol and 30 mL of ethyl acetate was dripped into the flask. The mixture was heated to 60° C. after the dripping, and was stirred for 6 hours. The mixture was cooled to 0° C., and 14.4 g (0.45 mol) of methanol was dripped into the mixture. The mixture was heated to 40° C. after the dripping, and was stirred for 3 hours. A reaction liquid was transported into 1.5 L of hexane, a precipitated solid was filtered, was washed with 1 L of hexane, and was dried, and thus 73.2 g of a compound 6-5 was obtained (a yield of 94%).

Weight Average Molecular Weight (Mw: 1407)

### Synthesis Example 22

### Synthesis of Compound 6-6

22.8 g (0.30 mol) of 1,2-propane diol, 1.1 g of Neostann U-600 (manufactured by NITTO KASEI CO., LTD.), and 200 ml of ethyl acetate were put into a three-neck flask which was attached with a mechanical stirrer, a thermometer, a cooling pipe, and a dripping funnel, and were cooled to 0° C., and a mixed solution of 44.4 g (0.20 mol) of isophorone diisocyanate and 10 mL of ethyl acetate was dripped into the flask. The mixture was heated to 60° C. after the dripping, and was stirred for 6 hours. A reaction liquid was transported into 1.5 L of hexane, and a precipitated solid was filtered, was washed with 1 L of hexane, and was dried, and thus 59.4 g of a compound 6-6 was obtained (a yield of 90%).

Weight Average Molecular Weight (Mw: 1271)

### Example 1

### Film Formation of Cellulose Acylate Film

### Preparation of Cellulose Acylate Solution

The following compositions were put into a mixing tank, each component was dissolved by being stirred, and thus a cellulose acylate solution was prepared.

Composition of Cellulose Acylate Solution

| | |
|---|---|
| Cellulose Acylate Having Degree of Acetyl | 100.0 parts by mass |
| Substitution of 2.87 and Degree of Polymerization | |
| of 370 | |
| Compound Shown in Table 2 Described below | 10.0 parts by mass |
| Methylene Chloride (First Solvent) | 353.9 parts by mass |
| Methanol (Second Solvent) | 89.6 parts by mass |
| n-Butanol (Third Solvent) | 4.5 parts by mass |

The cellulose acylate solution prepared as described above was casted by using a drum casting device. Peeling off was performed in a state where the amount of residual solvent in a dope was approximately 70 mass %, and drying was performed in a state where the amount of residual solvent was 3 mass % to 5 mass %. After that, the casted solution was transported between rolls of a heat treatment device, and was further dried, and thus a cellulose acylate film of Example 1 was obtained.

<Measurement of Surface Hardness of Cellulose Acylate Film>

A sample surface fixed to a glass substrate was measured in conditions of a loading time of 10 see, a creeping time of 5 sec, an offloading time of 10 sec, and a maximum load of 50 mN by a Knoop indenter in which the direction of a short axis of an indenter was arranged to be parallel to the transport direction (a longitudinal direction; a test direction in a pencil hardness test) at the time of forming the cellulose acylate film using a “Fischer Scope H100Vp type hardness meter” manufactured by Fischer Instruments K. K. The hardness was calculated from a relationship between the contact area of the indenter and the sample and the maximum load which were obtained from an indentation depth, and the average value of five points was set to surface hardness.

In addition, the sample surface fixed to the glass substrate was measured in conditions of a loading time of 10 sec, a creeping time of 5 sec, an offloading time of 10 sec, and an indentation load of 50 mN by using a “Fischer Scope H100Vp type hardness meter” manufactured by Fischer Instruments K. K. on the basis of a method of JIS Z 2251, and the hardness was calculated from the relationship between the contact area of the indenter and the sample and the maximum load which were obtained from the indentation depth. Furthermore, JIS Z 2251 was Japanese Industrial Standards prepared on the basis of ISO4545.

Further, in the same indentation position, the Knoop indenter was rotated by each 10°, Knoop hardness was measured at 18 directions in total, and thus the minimum value was obtained, and the minimum value was coincident with the surface hardness which was measured by arranging the direction of the short axis of the Knoop indenter described above to be parallel to the transport direction (the longitudinal direction; the test direction in the pencil hardness test) at the time of forming the cellulose acylate film.

The unit was denoted by N/mm², and the results of evaluation performed according to the following criteria were shown in Table.

A++: The Knoop hardness of greater than or equal to 230 N/mm²

A+: The Knoop hardness of greater than or equal to 220 N/mm² and less than 230 N/mm²

A: The Knoop hardness of greater than or equal to 210 N/mm² and less than 220 N/mm²

B: The Knoop hardness of greater than or equal to 200 N/mm² and less than 210 N/mm²

C: The knoop hardness of greater than or equal to 190 N/mm² and less than 200 N/mm²

D: The Knoop hardness of less than 190 N/mm²

<Evaluation Method of Photo-Coloration Suppression>

Light irradiation was performed with respect to each of the cellulose acylate films obtained as described above for 96 hours by using a super xenon weather meter (SX75, manufactured by Suga test Instruments Co., Ltd.), and the presence or absence of photo-coloration was evaluated according to a change in a hue b* before and after the irradiation. The evaluation was performed according to the following criteria, and the results were shown in Table.

The film hue b* was measured by using a spectrophotometer UV3150 manufactured by Shimadzu Corporation. When the value of the hue b* was increased on a minus side, a blue color of transmitted light was increased, and when the value of the hue b* was increased on a plus side, a yellow color of the transmitted light was increased.

A: A change width of b* before and after the irradiation of less than or equal to 0.1

B: The change width of b* before and after the irradiation of greater than 0.1 and less than or equal to 0.25

C: The change width of b* before and after the irradiation of greater than 0.25 and less than or equal to 0.40

D: The change width of b* before and after the irradiation of greater than 0.40

<Evaluation Method of Volatility>

A compound shown in Table 2 was heated from room temperature to 140° C. by using a TG/DTA measurement device (TG/DTA7200 manufactured by Hitachi High-Tech Science Corporation), a change in the mass of the compound at the time of being held at 140° C. for 1 hour was measured, and the volatility was determined in the following conditions.

In Table, when the change amount obtained by the measurement was less than or equal to 0.1%, the evaluation was denoted as “Absent”, and when the change amount obtained by the measurement was greater than or equal to 0.1%, the evaluation was denoted as “Present”.

TABLE 2

| | | | | | | | Structure of Additive | | | |
|---|---|---|---|---|---|---|---|---|---|---|
| | | | | | | | | Number of | | |
| | | | | | | | | Connecting | | |
| | Type and Amount of | | | | | | | Groups | | |
| | Additive | | | | | | | Selected from | | |
| | | Added | Film Performance | | | | | Group | | |
| Film | Compound | Amount | Knoop | | Photo- | | Molecular | Described | Equivalent | |
| No. | Number | (wt %*) | Hardness | | coloration | Volatility | Weight | above | Weight U | Note |
| 101 | 1-7 | 10 | 211 | A | A | Absent | 330 | 2 | 165 | Example |
| 102 | 1-9 | 10 | 232 | A++ | A | Absent | 364 | 2 | 182 | Example |
| 103 | 1-11 | 10 | 224 | A+ | A | Absent | 509 | 2 | 255 | Example |
| 104 | 1-14 | 10 | 220 | A+ | A | Absent | 617 | 2 | 309 | Example |
| 105 | 1-16 | 10 | 229 | A+ | A | Absent | 509 | 2 | 255 | Example |
| 106 | 2-2-A | 10 | 230 | A ++ | A | Absent | 484 | 2 | 242 | Example |
| | 2-2-B | | | | | | | | | |
| 107 | 2-3-A | 10 | 224 | A+ | A | Absent | 456 | 2 | 228 | Example |
| | 2-3-B | | | | | | | | | |
| 108 | 2-5-A | 10 | 220 | A+ | A | Absent | 388 | 2 | 194 | Example |
| | 2-5-B | | | | | | | | | |
| 109 | 2-6-A | 10 | 229 | A+ | A | Absent | 432 | 2 | 216 | Example |
| | 2-6-B | | | | | | | | | |
| 110 | 3-1 | 10 | 212 | A | A | Absent | 375 | 2 | 188 | Example |
| 111 | 3-7 | 10 | 215 | A | A | Absent | 450 | 2 | 225 | Example |
| 112 | Comparative | 10 | 204 | B | D | Absent | 484 | 2 | 242 | Comparative |
| | Compound A | | | | | | | | | Example |
| 113 | Comparative | 10 | 201 | B | C | Present | 221 | 1 | 221 | Comparative |
| | Compound B | | | | | | | | | Example |
| 114 | Comparative | 10 | * | | | | 340 | 2 | 170 | Comparative |
| | Compound C | | | | | | | | | Example |
| 115 | Absent | 0 | 180 | D | A | — | — | — | — | Comparative |
| | | | | | | | | | | Example |
| 116 | 4-6 | 10 | 215 | A | A | Absent | 426 | 4 | 107 | Example |
| 117 | 4-10 | 10 | 211 | A | A | Absent | 483 | 4 | 121 | Example |
| 118 | 5-1 | 10 | 220 | A+ | A | Absent | 387 | 3 | 129 | Example |
| 119 | 5-2 | 10 | 224 | A+ | A | Absent | 489 | 4 | 122 | Example |
| 120 | 5-4 | 10 | 221 | A+ | A | Absent | 373 | 4 | 93 | Example |
| 121 | 5-6 | 10 | 229 | A+ | A | Absent | 489 | 4 | 122 | Example |
| 122 | 6-1 | 10 | 219 | A | A | Absent | 585 | 4 | 146 | Example |
| 123 | 6-2 | 10 | 227 | A+ | A | Absent | 516 | 4 | 129 | Example |
| 124 | 6-3 | 10 | 229 | A+ | A | Absent | 595 | 4 | 149 | Example |
| 125 | 6-5 | 10 | 212 | A | A | Absent | 1407 | 9.5 | 148 | Example |

* A cellulose acetate solution prepared. by adding a comparative compound C was not completely dissolved, and thus a film was not able to be prepared.
* wt % is mass % of an additive with respect to 100 mass % of cellulose aeylate. In a film in which two types of additives were used, the mixture obtained in the synthesis example was used.

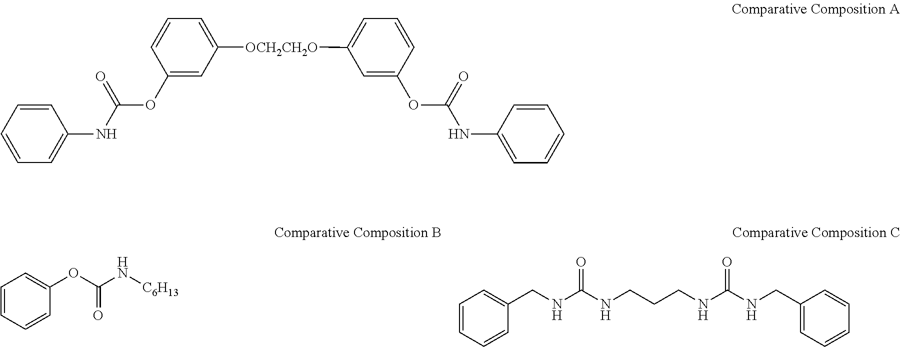

A comparative compound A is a compound A-23 disclosed in JP2005-272566A, a comparative compound B is a compound A-32 disclosed in JP2005-272566A, and a comparative compound C is a compound (53) described in compounds disclosed in JP2002-322294A.

The Knoop hardness is an index indicating the surface hardness of the film. All of the compounds used in the examples are able to form a film exhibiting higher surface hardness than the comparative compounds A and B. It is considered that the compound used in the example includes the connecting group selected from the group described above along with the polar group, and thus suppresses the movement of a molecular chain of the cellulose acylate, and contributes to improvement in the surface hardness. More specifically, it is assumed that a proton position in the connecting group selected from the group described above effectively acts on an ester bond or a hydroxyl group of the cellulose acylate and forms a hydrogen bond, and thus contributes to suppression of the movement of the molecular chain of the cellulose acylate. In contrast, it is assumed that the reason that the comparative compounds A and B have a less surface hardness improvement effect of the cellulose acylate film than the compound used in the example is because the compounds of a comparative example do not have a polar group (the residue of the compound having C log P of less than or equal to 0.85).

In addition, as shown in Table 2, in all of the films of the examples, the photo-coloration was sufficiently suppressed. It is considered that a substituent group adjacent to an oxygen atom or a nitrogen atom of the connecting group selected from the group described above considerably contributes to suppression of the photo-coloration. The present inventors have considered that the reason that the photo-coloration is suppressed in the film of the example is because an aromatic ring is not directly bonded to the oxygen atom or the nitrogen atom of the connecting group selected from the group described above.

In contrast, in the film of a comparative example containing the comparative compound A, it is considered that the reason that the evaluation result relevant to the suppression of the photo-coloration is D is because the oxygen atom and the nitrogen atom of the connecting group selected from the group described above are directly bonded to a benzene ring.

Further, from the results shown in Table 2, it is possible to confirm that the compound added to the film of the example has small volatility, and thus is able to manufacture a cellulose acylate film having excellent transparency. In contrast, the comparative compound B had inferior volatility. The present inventors have assumed that a difference in the volatility between the compound added to the film of the example and the comparative compound B mainly depends on a difference in the molecular weights.

In contrast, the comparative compound C had inferior compatibility with respect to the cellulose acylate, and thus was able to prepare a film. It is considered that this is mainly because the comparative compound C does not have a polar group. In addition, a compound having two or more bivalent connecting groups denoted by —NH—(C═O)—NH— in the molecules, such as the comparative compound C tends to have inferior compatibility with respect to the cellulose acylate, and thus it is preferable that in the present invention, the compound added to the cellulose acylate film does not have a bivalent connecting group denoted by —NH—(C═O)—NH— in one molecule or has only one bivalent connecting group denoted by —NH—(C═O)—NH— in one molecule.

From the results, it is possible to confirm that the film of the example is a cellulose acylate film having high surface hardness and reduced photo-coloration, and the compound added to the film of the example has reduced volatilization.

### Example 1-2

A cellulose acylate film was prepared by the same method as that in Example 1 except that the type and the added amount of each of the additives were changed as shown in Table described below.

Each of the properties was evaluated by the same method as that in Example 1.

TABLE 3

| | | Added | Film Performance | | | | |
|---|---|---|---|---|---|---|---|
| Film | Compound | Amount | Knoop | | Photo- | | |
| No. | Number | (wt %*) | Hardness | | coloration | Volatility | Note |
| 201 | 1-9 | 5 | 210 | A | A | Absent | Example |
| 202 | 1-9 | 20 | 246 | A++ | A | Absent | Example |
| 203 | 2-6-A | 5 | 210 | A | A | Absent | Example |
| | 2-6-B | | | | | | |
| 204 | 2-6-A | 7.5 | 224 | A+ | A | Absent | Example |
| | 2-6-B | | | | | | |

*wt % is mass % of an additive with respect to 100 mass % of cellulose acylate. In a film in which two types of additives were used, the mixture obtained in the synthesis example was used.

As it is obvious from Table 3, the compound described above is able to improve the surface hardness of the film by increasing the added amount. In addition, even when the additive is added in a small amount (a film 201 and a film 203), the surface hardness is considerably improved compared to the comparative compound or a film to which the additive is not added, and the range of the amount of additive able to be added is broad.

### Example 2

A cellulose acylate film was prepared by the same method as that in Example 1 except that the degree of substitution of the cellulose acylate and the type of each of the additives were changed as shown in Table described below.

Each of the properties was evaluated by the same method as that in Example 1.

The value of the Knoop hardness of each of the films was evaluated in the following criteria, compared to the value of the Knoop hardness of the film which was prepared without being added with the additive.

A: Greater than or equal to 1.15 times the value of the Knoop hardness at the time of not adding the additive

B: Greater than or equal to 1.05 times and less than 1.15 times the value of the Knoop hardness at the time of not adding the additive

C: Greater than or equal to 1.00 times and less than 1.05 times the value of the Knoop hardness at the time of not adding the additive

D: Less than 1.00 times the value of the Knoop hardness at the time of not adding the additive

TABLE 4

| | Cellulose Acylate | Additive | | Film | Film Performance | | | |
|---|---|---|---|---|---|---|---|---|
| Film | Degree of Acetyl | Compound | Added Amount | Thickness | Knoop | Photo- | | |
| No. | Substitution | Number | (wt %*) | (μm) | Hardness | coloration | Volatility | Note |
| 301 | 2.42 | 1-9 | 10 | 52 | A | A | Absent | Example |
| 302 | 2.42 | 1-14 | 10 | 60 | B | A | Absent | Example |
| 303 | 2.77 | 2-3-A | 10 | 63 | A | A | Absent | Example |
| | | 2-3-B | | | | | | |
| 304 | 2.93 | 1-9 | 10 | 55 | A | B | Absent | Example |
| 305 | 2.93 | 1-14 | 10 | 57 | B | A | Absent | Example |
| 306 | 2.93 | 2-3-A | 10 | 56 | A | A | Absent | Example |
| | | 2-3-B | | | | | | |
| 307 | 2.87 | 3-9 | 10 | 62 | A | A | Absent | Example |
| 308 | 2.87 | 3-13 | 10 | 61 | A | A | Absent | Example |
| 309 | 2.87 | 3-20 | 10 | 59 | A | A | Absent | Example |
| 310 | 2.87 | 3-21 | 10 | 63 | A | A | Absent | Example |
| 311 | 2.87 | 3-22 | 10 | 62 | A | A | Absent | Example |

*wt % is mass % of an additive with respect to 100 mass % of cellulose acylate. In a film in which two types of additives were used, the mixture obtained in the synthesis example was used.

As shown in Table 4, in the compound described above, it was found that preferred surface hardness was able to be expressed without depending on the degree of substitution of the cellulose acylate.

### Example 3

A cellulose acylate film was prepared by the same method as that in Example 1 except that the type of cellulose acylate, the type of each of the additives, and the film thickness of the cellulose acylate film were changed as shown in Table described below.

Each of the properties was evaluated by the same method as that in Example 1. Here, when the surface hardness was evaluated, as described below, surface hardness of a film having a film thickness of less than or equal to 40 m was measured by changing a indentation load to 20 mN.

<Evaluation of Surface Hardness of Cellulose Acylate Film>

The surface hardness of the cellulose acylate film obtained as described above was measured by the same method as that in Example 1 except that an indentation load was changed as described above. The unit was denoted by N/mm².

The value of the Knoop hardness of each of the films was evaluated in the following criteria, compared to the value of the Knoop hardness of the film which was prepared without being added with the additive.

A: Greater than or equal to 1.15 times the value of the Knoop hardness at the time of not adding the additive

B: Greater than or equal to 1.05 times and less than 1.15 times the value of the Knoop hardness at the time of not adding the additive

C: Greater than or equal to 1.00 times and less than 1.05 times the value of the Knoop hardness at the time of not adding the additive

D: Less than 1.00 times the value of the Knoop hardness at the time of not adding the additive

TABLE 5

| | Cellulose Acylate | Additive | | Film | Film Performance | | | |
|---|---|---|---|---|---|---|---|---|
| Film | Degree of Acetyl | Compound | Added Amount | Thickness | Knoop | Photo- | | |
| No. | Substitution | Number | (wt %*) | (μm) | Hardness | coloration | Volatility | Note |
| 401 | 2.86 | 1-9 | 12 | 28 | A | A | Absent | Example |
| 402 | 2.86 | 1-14 | 12 | 29 | A | A | Absent | Example |
| 403 | 2.86 | 2-3-A | 12 | 24 | A | A | Absent | Example |
| | | 2-3-B | | | | | | |
| 404 | 2.86 | 1-9 | 12 | 42 | B | A | Absent | Example |

*wt % is mass % of an additive with respect to 100 mass % of cellulose acylate. In a film in which two types of additives were used, the mixture obtained in the synthesis example was used.

As shown in Table 5, in the compound described above, it was found that preferred surface hardness was able to be expressed even when the film was thinned.

### Example 4

### Preparation of Optical Film Attached with Hard Coat Layer

A hard coat layer solution having the following curable composition was applied onto the surface of an optical film of a single layer formed of the cellulose acylate which was prepared in each of Example 1 and Example 2 described above, and was cured by ultraviolet irradiation, and thus an optical film attached with a hard coat layer was prepared on which a hard coat layer having a thickness of 6 μm was formed.

Curable Composition of Hard Coat Layer Solution

| | |
|---|---|
| Monomer Pentaerythritol Triacrylate/Pentaerythritol | 53.5 parts by mass |
| Tetraacrylate (Mixed Mass Ratio of 3/2) | |
| Photopolymerization Initiator Irgacure (Japanese | 1.5 parts by mass |
| Registered Trademark) TM907 | |
| (manufactured by BASF SE) | |
| Ethyl Acetate | 45 parts by mass |

(Pencil Hardness Evaluation)

The humidity of each of the cellulose acylate films attached with a hard coat layer was adjusted for 2 hours in conditions of a temperature of 25° C. and relative humidity of 60%, and the pencil hardness was measured by using a pencil for a test defined in JIS-S6006 according to a pencil hardness evaluation method defined in JIS-K5400 such that the surface of the hard coat layer was repeatedly scratched 5 times with a pencil with each hardness by using a weight of 500 g, and the hardness was measured until the number of defects became 1. Furthermore, it is disclosed that a defect defined in JIS-K5400 is a breakage of a coated film and a scratch of the coated film, but concavity of the coated film is not a target, but in this evaluation, the concavity of the coated film was also determined as a defect. It is practically preferable the pencil hardness is greater than or equal to 3H, and high hardness is obtained as the numerical value becomes greater, and thus increasing the numerical value is preferable. As a result thereof, it was found that all of films Nos. 102, 104, 106, 107, 201, and 202 of the examples had high evaluation of 3H, compared to a film No. 115 having evaluation of 2H to which the additive was not added.

### Example 5

### Preparation of Polarizing Plate

Saponification Treatment of Polarizing Plate Protective Film

Each of the cellulose acylate films which were obtained in Example 1 was dipped in 2.3 mol/L of an aqueous solution of sodium hydroxide at 55° C. for 3 minutes. The cellulose acylate film was washed in a water washing bath at room temperature, and was neutralized at 30° C. by using 0.05 mol/L of a sulfuric acid. The cellulose acylate film was washed again in the water washing bath at room temperature, and was further dried with hot air at 100° C. Thus, a saponification treatment was performed with respect to the surface of the cellulose acylate film.

Preparation of Polarizing Plate

Iodine was adsorbed in a stretched polyvinyl alcohol film, and was aligned, and thus a polarizer was prepared.

The cellulose acylate film which had been subjected to the saponification treatment was bonded to one side of the polarizer by using a polyvinyl alcohol-based adhesive agent. A commercially available cellulose triacetate film (Fujitac (Japanese Registered Trademark) TD80UF, manufactured by Fujifilm Corporation) was also subjected to the same saponification treatment, and was bonded to the surface of the polarizer on a side opposite to the surface side onto which the cellulose acylate film prepared as described above was bonded by using the polyvinyl alcohol-based adhesive agent.

At this time, a transmission axis of the polarizer and a slow axis of the obtained cellulose acylate film were arranged to be parallel to each other. In addition, the transmission axis of the polarizer and a slow axis of the commercially available cellulose triacetate film were arranged to be orthogonal to each other.

Thus, Each Polarizing Plate was Prepared.

<Evaluation of Polarizing Plate Durability>

A polarizing plate durability test was performed in a state where the polarizing plate was bonded to glass through a pressure-sensitive adhesives as follows.

Two samples (approximately 5 cm×5 cm) were prepared in which the polarizing plate was bonded onto glass such that the cellulose acylate film of the example prepared in Example 1 was on an air boundary side. Orthogonal transmittance measurement of a single plate was performed by setting a side of the cellulose acylate film of the example obtained in Example 1 in this sample to be directed towards a light source. The orthogonal transmittance of the plate was measured in a range of 380 nm to 780 nm by using an automatic polarizing film measurement device VAP-7070 manufactured by Jasco Corporation, and a measured value at 410 nm was adopted. Each of the two samples was measured, and the average value thereof was set to orthogonal transmittance of the polarizing plate. After that, each of the polarizing plates was aged and held for 120 hours under an environment of a temperature of 80° C. and relative humidity of 90% RH, and the orthogonal transmittance was measured by using the same method. A change in the orthogonal transmittance before and after aging was obtained, and the change was evaluated as the polarizing plate durability. Furthermore, relative humidity under an environment where the humidity was not adjusted was in a range of 0% RH to 20% RH.

It was found that in the film No. 102 and the film No. 104 of the example of Example 1, the change in the orthogonal transmittance before and after aging decreased, and the added compound improved the polarizing plate durability, compared to the film No. 115 in which the additive was not included.

### Example 6

### Preparation of Liquid-Crystal Display Device

A polarizing plate on a visible side of a commercially available liquid-crystal television (Bravia (Japanese Registered Trademark) J5000, manufactured by SONY Corporation) was peeled off, and each of the polarizing plates prepared in the examples was bonded to the liquid-crystal television on an observer side through a pressure-sensitive adhesives such that each of the polarizing plate protective films of the examples was on a side opposite to the liquid-crystal cell side, and thus a liquid-crystal display device was obtained.

### EXPLANATION OF REFERENCES

1: cellulose acylate film
2: polarizer
3: retardation film
4: liquid-crystal cell
10: upper side polarizing plate

What is claimed is:

1. A cellulose acylate film containing a compound having at least one connecting group selected from a group consisting of a bivalent connecting group denoted by —NH—(C═O)—O- and a bivalent connecting group denoted by —NH—(C═O)—NR— in which R represents a hydrogen atom or a substituent group, and at least one polar group which is a residue of a compound having a C log P value of less than or equal to 0.85,
wherein an aromatic hetero ring-containing group which is a residue of a compound having a C log P value of less than or equal to 0.85 is excluded from the polar group, and
an equivalent weight U obtained as a value which is obtained by dividing a molecular weight by the number of connecting groups included in one molecule is less than or equal to 515.

2. The cellulose acylate film according to claim 1,
wherein the compound has at least one of the polar groups as a terminal substituent group.

3. The cellulose acylate film according to claim 2,
wherein the polar group is selected from a group consisting of a cyano group, a cyclic imide group, an alkoxy carbonyl group, a hydroxyl group, an alkyl aminocarbonyl oxy group, an alkoxy carbonyl amino group, and an alkyl aminocarbonyl amino group.

4. The cellulose acylate film according to claim 1,
wherein the compound is a compound denoted by Formula A described below, and
Q^{A}-L¹-X—C(═O)—NH-L²-Q^{B} Formula A
in Formula A, X represents —O— or —NR—, and R represents a hydrogen atom or a substituent group; L¹ and L² each independently represent a single bond, or any one of an alkylene group, an arylene group, —O—, —NR¹—, —S—, and —C(═O)— or a group formed of a combination of two or more types thereof; R¹ represents a hydrogen atom or a substituent group; Q^{A} and Q^{B} each independently represent a substituent group, and at least one of Q^{A} and Q^{B} represents the polar group or the terminal group included in the polar group; and X represents —NR—, L¹ represents a single bond, and when Q^{A} has a ring structure, the ring structure included in Q^{A} may be a ring structure formed along with R of —NR—.

5. The cellulose acylate film according to claim 4,
wherein the compound denoted by Formula A is a compound denoted by Formula A-1 described below, and
(Q¹-L¹¹-A-L²¹)ₘ-Z¹ Formula A-1
in Formula A-1, L¹¹ and L²¹ each independently represent a single bond, or any one of an alkylene group, an arylene group, —O—, —NR¹—, —S—, and —C(═O)— or a group formed of a combination of two or more types thereof; R¹ represents a hydrogen atom or a substituent group; Q¹ represents a substituent group, Z¹ represents a m-valent connecting group, A represents a single bond, *—X—C(═O)—NH—, or *—NH—C(═O)—X—, * represents a bonding position with respect to L²¹, X represents —O— or —NR—, and R represents a hydrogen atom or a substituent group; m represents an integer in a range of 2 to 6, and a plurality of Q¹s, As, L¹¹s and L²¹s may be identical to each other or different from each other, respectively; and at least one A represents *—X—C(═O)—NH— or *—NH—C(═O)—X—, and at least one Q¹ represents the polar group or the terminal group included in the polar group.

6. The cellulose acylate film according to claim 5,
wherein in Formula A-1, the connecting group represented by Z¹ is a chain aliphatic group or a cyclic aliphatic group, or an aromatic group.

7. The cellulose acylate film according to claim 5,
wherein in Formula A-1, at least one of L¹¹, L²¹, Q¹, and Z¹ has a ring structure.

8. The cellulose acylate film according to claim 5,
wherein in Formula A-1, the polar group represented by at least one of the plurality of Q¹s has a ring structure.

9. The cellulose acylate film according to claim 5,
wherein in Formula A-1, at least one of the plurality of Q¹s is the terminal group included in the polar group, and the terminal group is an alkyl group.

10. The cellulose acylate film according to claim 5,
wherein in Formula A-1, at least one of the plurality of Q¹s is the terminal group included in the polar group, L¹¹ adjacent to Q¹ which is the terminal group is a single bond, and the polar group is configured of Q¹ and A represented by *—X—C(═O)—NH— or *—NH—C(═O)—X—.

11. The cellulose acylate film according to claim 5,
wherein in Formula A-1, m is 2 or 3.

12. The cellulose acylate film according to claim 5,
wherein in Formula A-1, L²¹ of at least one constituent unit of a plurality of constituent units denoted (Q¹-L¹¹-A-L²¹) is a single bond, and in the constituent unit, A represents *—NH—C(═O)—X— and is bonded to Z¹ in a bonding position *.

13. The cellulose acylate film according to claim 1,
wherein the compound is selected from a group consisting of a compound denoted by Formula A-4 described below and a compound denoted by Formula A-5 described below, and 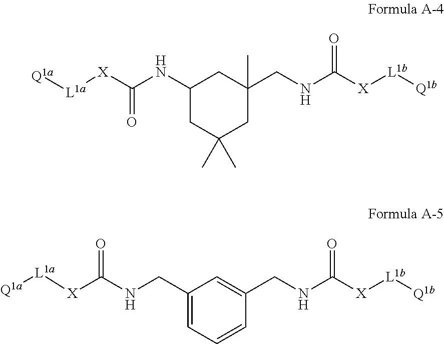
in Formulas A-4 and A-5, L^{1a} and L^{1b} each independently represent a single bond, or any one of an alkylene group, an arylene group, —O—, and —C(—O)— or a group formed of a combination of two or more thereof; X represents —O— or —NR—, and R represents a hydrogen atom or a substituent group; a plurality of Xs may be identical to each other or different from each other; Q^{1a} and Q^{1b} each independently represent a cyano group, a hydroxyl group, a succinimide group, a hexahydrophthalimide group, a methoxy carbonyl group, an alkoxy carbonyl amino group, an alkyl aminocarbonyl oxy group, an alkyl aminocarbonyl amino group, an alkyl group, a phenyl group, or a benzyl group, or when adjacent L^{1a} or L^{1b} represents a single bond, and X represents —NR—, Q^{1a} and Q^{1b} each independently represent a morpholino group formed along with R of —NR—; and at least one of Q^{1a} and Q^{1b} represents the polar group or the terminal group included in the polar group.

14. The cellulose acylate film according to claim 13,
wherein the compound is a compound denoted by Formula A-4 above.

15. The cellulose acylate film according to claim 13,
wherein the compound is a compound denoted by Formula A-5 above.

16. The cellulose acylate film according to claim 1,
wherein a content of the compound is in a range of 1 part by mass to 50 parts by mass with respect to 100 parts by mass of cellulose acylate.

17. A polarizing plate, comprising:
the cellulose acylate film according to claim 1; and
a polarizer.

18. A liquid-crystal display device, comprising:
the polarizing plate according to claim 17.

19. The liquid-crystal display device according to claim 18,
wherein the liquid-crystal display device includes the polarizing plate at least on a visible side.
